(19) United States
(12) Patent Application Publication
(10) Pub. No.: US 2026/0301075 A1
(43) Pub. Date: Oct. 1, 2026

(54) Systems and Methods for AI-Driven Ownership Allocation and Receipt-Native Multilateral Netting to Maximize Collective Economic Benefit

(71) Applicant: Thomas Hecht, Cambridge, MA (US)

(72) Inventor: Thomas Hecht, Cambridge, MA (US)

(21) Appl. No.: 19/458,980

(22) Filed: Jan. 26, 2026

Related U.S. Application Data
(63) Continuation-in-part of application No. 19/051,264, filed on Feb. 12, 2025, now Pat. No. 12,561,745.

(51) Int. Cl. G06Q 40/06; G06Q 10/1057

(52) U.S. Cl. CPC G06Q 40/0631; G06Q 10/1057

(57) ABSTRACT

A computing system allocates and reallocates ownership of an asset to maximize collective economic benefit while preserving continuity of usage. The system ingests asset-utilization transactions, user profiles, and supplemental outcome datasets, and executes an AI/ML categorization engine, optionally accelerated by specialized hardware, to generate a predicted most-efficient-use vector and an ownership-inefficiency score. When an inefficiency threshold is met, the system queries an ownership-entity database, selects a specialized ownership wrapper, and encodes and executes a transaction that transfers legal title to the wrapper while granting the user usage rights under a lease, rental, license, or other agreement and computing a benefit-sharing parameter. The system generates cryptographically verifiable receipts and optional multilateral netting and atomic settlement instructions that compress transaction legs and support deterministic replay. Domain embodiments include benefits orchestration, labor and tax compliance, nonprofit ownership, and household or intercompany netting.

### CROSS-REFERENCE TO RELATED APPLICATIONS

This application is a continuation-in-part of U.S. patent application Ser. No. 19/051,264, filed Feb. 12, 2025, titled “Artificial Intelligence Systems and Methods for Efficient Use of Assets,” published as U.S. Patent Application Publication No. US 2025/0182211 A1 on Jun. 5, 2025.

### STATEMENT REGARDING FEDERALLY SPONSORED RESEARCH OR DEVELOPMENT

This invention was not made with government support and the government has no rights in the invention.

### NAMES OF THE PARTIES TO A JOINT RESEARCH AGREEMENT

Not applicable.

### REFERENCE TO A COMPUTER PROGRAM LISTING APPENDIX, A SEQUENCE LISTING, AND/OR A LARGE TABLE

Not applicable. No computer program listing appendix, sequence listing, or large tables are submitted herewith.

### STATEMENT REGARDING PRIOR DISCLOSURES BY THE INVENTOR OR A JOINT INVENTOR

Not applicable.

### INCORPORATION BY REFERENCE

The entire contents of each of the U.S. patents, U.S. patent application publications, and U.S. patent applications identified below are incorporated herein by reference to the extent permitted by applicable law and regulations, including 37 C.F.R. § 1.57.

No essential material is incorporated by reference except as permitted under 37 C.F.R. § 1.57(d). In the event of any inconsistency between an incorporated document and the present disclosure, the present disclosure controls.
U.S. Patent Application Publication No. US 2016/0225081 A1 (published Aug. 4, 2016), titled “Method and system of supplying loaned funds to employees for increased participation in Employee Stock Option Plans.”
U.S. Patent Application Publication No. US 2021/0295432 A1 (published Sep. 23, 2021), titled “Method and System of Supplying Loaned Funds to Employees for Increased Participation in Employee Stock Option Plans.”
U.S. Patent Application Publication No. US 2023/0214920 A1 (published Jul. 6, 2023), titled “Method of supplying loaned funds to employees for increased participation in a broad-based employee stock ownership plan, or in an employer-provided retirement plan.”
U.S. Patent Application Publication No. US 2024/0330865 A1 (published Oct. 3, 2024), titled “System and Method of Cooperatively Optimizing Compensation Benefits for Employer and Worker.”
U.S. Patent Application Publication No. US 2025/0005638 A1 (published Jan. 2, 2025), titled “Aggregating Asset Value and Marshalling Cooperation to Achieve Economic Benefits and Social Good.”
U.S. Patent Application Publication No. US 2025/0005670 A1 (published Jan. 2, 2025), titled “Asset allocation for optimization of collective economic benefit.”
U.S. Patent Application Publication No. US 2025/0156959 A1 (published May 15, 2025), titled “Computer-Implemented Systems and Methods for Dispersion of Closing Cycles.”
U.S. Patent Application Publication No. US 2025/0182211 A1 (published Jun. 5, 2025), titled “Artificial Intelligence Systems and Methods for Efficient Use of Assets.”
U.S. patent application Ser. No. 18/652,061 (filed May 1, 2024), titled “Supplying Loaned Funds to Employees for ESOP Participation.”
U.S. patent application Ser. No. 18/658,420 (filed May 8, 2024), titled “A System for Comprehensive Asset Valuation and Optimization and a Method Thereof.”

### FIELD OF THE INVENTION

The present disclosure relates generally to computer-implemented systems for allocating and reallocating asset ownership while preserving usage rights, and more particularly to receipt-native computing architectures that (i) predict the most efficient use of assets using artificial intelligence, (ii) select specialized ownership entities optimized for economic outcomes, (iii) execute legally binding title transfer and usage-preservation transactions, and (iv) reduce transaction count and intermediary dependency through multilateral netting, atomic settlement, and auditable digital receipts.

### BACKGROUND OF THE INVENTION

The following discussion is intended to provide background for the present disclosure. Nothing in this section should be construed as an admission that any reference, technique, system, product, or other information is prior art, is publicly known, or forms part of the common general knowledge. The applicant expressly reserves the right to challenge any such characterization. References to statutes, regulations, standards, or guidance are provided for contextual description only and are not intended to admit applicability, scope, or compliance obligations in any particular jurisdiction.

Across many industries, value is lost or trapped because ownership is rigid while usage needs are dynamic. Individuals and organizations often underutilize assets or opportunities (for example: benefit entitlements, time/capacity, liquidity, real property, equipment, or contractual rights) but cannot conveniently convert those latent values into usable outcomes without intermediaries. Intermediaries can include, without limitation, brokers, agents, marketplaces, processors, managers, platforms, auditors, administrators, custodians, government-facing filing services, and other middle layers that coordinate and verify transactions. Each layer can introduce cost, latency, duplicated recordkeeping, risk concentration, and privacy exposure.

In conventional systems, ownership and usage are frequently bound together, such that a party must hold legal title in order to use an asset, and must surrender usage to transfer the asset. This constraint is especially visible in regulated contexts, where restrictions exist to protect participants or to enforce tax and labor rules. For example, participation in certain employee benefit programs (such as employee stock purchase plans and retirement contributions) may be limited by eligibility rules, tax limits, payroll deduction mechanics, and non-transferability of the underlying entitlements. Similarly, worker classification (W-2 employee versus 1099 independent contractor) is governed by multi-factor legal tests that vary by jurisdiction, evolve over time, and can carry significant penalties if applied incorrectly. These protective constraints can still create barriers to efficient economic coordination, particularly when households and small organizations attempt to optimize across multiple employers, plans, and life events.

Conventional platforms typically optimize within a single silo (a payroll system, a benefits administrator, a brokerage, an accounting package, or a marketplace) and communicate via coarse integrations. The result is excessive transaction count, redundant data transformations, fragmented policy application, and manual reconciliation. When rules change (tax thresholds, plan limits, safe harbors, or jurisdictional tests), the updates are often applied through full recomputation or manual overrides, further increasing operational friction and error rates.

There is accordingly a need for computing systems that can: (i) represent ownership, usage rights, and constraints in machine-actionable data structures; (ii) predict and optimize economic outcomes across heterogeneous assets and domains; (iii) execute title-transfer and usage-preservation transactions as verifiable, auditable events; and (iv) compress transactions by netting and by internalizing intermediary steps, while maintaining compliance, security, and privacy.

Identity and eligibility evidence is also fragmented across organizations. Conventional identity and credentialing systems are often siloed, leading to repeated manual verification of “who is allowed to do what” and to oversharing of sensitive personal data. Revocation and status checking of eligibility evidence over time can be difficult to audit across systems, which in turn increases reliance on intermediaries and manual controls.

Time coordination further compounds inefficiency. Business processes such as payroll, benefits, tax remittance, and financial close are frequently driven by periodic deadlines and inconsistent calendars, producing deadline-induced congestion, bursts of transaction volume, and brittle reconciliation workflows. These conditions increase cost, error, and risk and create opportunities for intermediaries to extract fees.

### BRIEF SUMMARY OF THE INVENTION

In embodiments, a computing system allocates and reallocates asset ownership to maximize a measured collective economic benefit while preserving continuity of usage for one or more users. The system ingests information about a user and an asset and ingests asset-utilization transaction data for a user-asset pair, including historical sale, lease, usage, and user-profile records. The system further retrieves supplemental datasets of economic outcomes and user demographics and executes an artificial intelligence (AI) categorization engine that predicts one or more most-efficient uses of the asset as a most-efficient-use vector.

In some embodiments, the AI categorization engine is implemented using an application-specific integrated circuit (ASIC) that accelerates an artificial neural network. During training and/or inference, the system may store network weights and activations as 32-bit floating-point variables and statically quantize at least the network weights to 8-bit integers to reduce storage footprint and improve inference throughput. The ASIC may execute a functionally-invariant-path (FIP) algorithm that updates network weights along differential-geometry paths so as to preserve learned behavior while increasing sparsity, thereby improving compute and memory efficiency as new data is accumulated.

The system compares AI output to a declared or observed usage pattern and flags a projected ownership inefficiency that meets or exceeds a threshold. In response, the system queries an ownership-entity database and returns a ranked candidate list of specialized ownership entities. The system computes an objective function representing expected collective economic benefit across the candidate list and selects a top-ranked entity. The system then encodes and executes a transaction that transfers legal title to the selected entity while preserving usage rights for the user. The transaction may include generating and storing a conveyance record designating the selected entity as owner and a usage agreement (for example: lease, rental, access license, or long-term usage agreement) granting possession or access to the user. The system may compute and store a benefit-sharing parameter to redistribute at least a portion of the economic benefit back to one or more users.

In embodiments, the system is receipt-native: each title-transfer routine and related settlement actions generate cryptographically verifiable receipts that are stored in an append-only event ledger. The receipts enable deterministic replay, audit, compliance evidence, and measured surplus attribution. In some embodiments, for each settlement cycle, the system computes multilateral netting across a consented clearing group so as to reduce gross settlement volume, internalize intermediary steps, and compress transaction count. Netting outcomes and downstream payments are bound into proof-of-netting receipts that reference gross vectors, offsets, exclusions, cycle identifiers, and correlation identifiers, and the system may execute an atomic settlement group across heterogeneous payment rails (for example: bank rails and programmable/token rails).

In embodiments, domain-specific constraints (such as labor classification rules, payroll and benefits plan rules, tax rules, and eligibility constraints) are compiled into versioned rulepacks and applied as constraints within the ownership allocation and netting loops. Rulepacks may be jurisdiction-specific, effective-date scoped, and cryptographically hashed so that each decision receipt binds to the precise rulepack version used. Optional embodiments implement a change-of-law ingestion and compilation pipeline that updates rulepacks and triggers recomputation, enabling continuous compliance.

These and other embodiments provide a repeatable, scalable kernel: predict->compare->select->encode->execute->receipt->repeat. Domain-specific embodiments (for example: ESPP/401(k) benefit autopilot, W-2/1099 classification under ACA safe harbors, intercompany and household netting, nonprofit and philanthropic enterprise ownership wrappers, and asset lifecycle transitions) may be expressed as dependent configurations of the same kernel while sharing common data structures, receipt formats, and execution primitives. In embodiments, the kernel disintermediates staged processing by computing netting vectors and executing atomic settlement groups that reduce settlement legs, intermediary hops, and reconciliation operations while producing verifiable receipt evidence.

In some embodiments, the disclosed architecture provides technical improvements to the functioning of computing systems and computer networks, including: (i) reducing model storage and memory bandwidth via static quantization of neural-network weights and activations; (ii) reducing inference and update latency via hardware acceleration (e.g., an ASIC neural network accelerator) and data locality management including dataset shard migration and prefetching; (iii) reducing the number of settlement messages and network traffic via multilateral netting and coordinated (atomic) execution across heterogeneous transaction rails; and (iv) improving security, traceability, and auditability via cryptographically verifiable, typed receipts stored in an append-only event ledger supporting deterministic replay. In some embodiments, transaction compression, intermediary internalization control, and receipt-spine compression reduce message count, storage overhead, and attack surface while preserving deterministic replay and independent verification.

In some embodiments, eligibility, role, consent, and constraint evidence is expressed as machine-verifiable credentials and predicates that can be verified without exposing underlying personally identifiable information. For example, a participant may present a selective-disclosure proof that a rulepack predicate is satisfied (e.g., “full-time employee”, “plan-eligible”, “affordability threshold satisfied”), and the system binds such proofs into Proof-of-Classification, Proof-of-Benefit, or Proof-of-Netting receipts to support regulator-grade auditability.

In some embodiments, the system further improves correctness and reduces reconciliation by normalizing heterogeneous timebases (e.g., payroll cycles, plan offering windows, fiscal calendars) into settlement identifiers and period labels used consistently across receipt bundles, netting cycles, and atomic settlement groups.

### BRIEF DESCRIPTION OF THE DRAWINGS

The accompanying drawings illustrate example embodiments and are not intended to limit the scope of the invention. In the drawings, like reference numerals generally refer to like elements.

FIG. 1 illustrates an example system architecture (100) for AI-driven ownership allocation and receipt-native multilateral netting, including inputs/participants (100), external connectors (110), an intake and normalization module (120), an AI/ML categorization module (130), an entity selection module (140), a transaction execution module (150), a receipt ledger module (160), a netting and settlement module (170), and a policy/rulepack module (180).

FIG. 2 illustrates example data structures (200) for an ownership and usage state representation, including an asset/resource record (210), an ownership entity record (220), a usage rights record (230), a most-efficient-use vector (240), and receipt objects (250) including Proof-of-Netting (PoN), Proof-of-Benefit (PoB), and Proof-of-Classification (PoC).

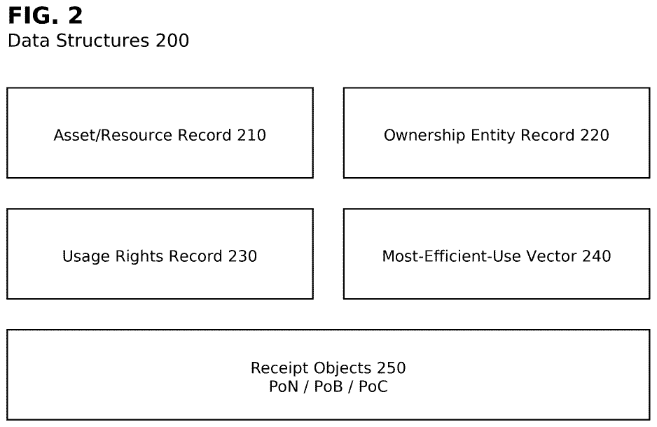

FIG. 3 illustrates an example AI/ML inference, optimization, and compression pipeline (300), including feature ingestion (310), quantize/compress (320), model inference (330), optimization (340), threshold/delta evaluation (350), and a functionally-invariant-path (FIP) update loop (360).

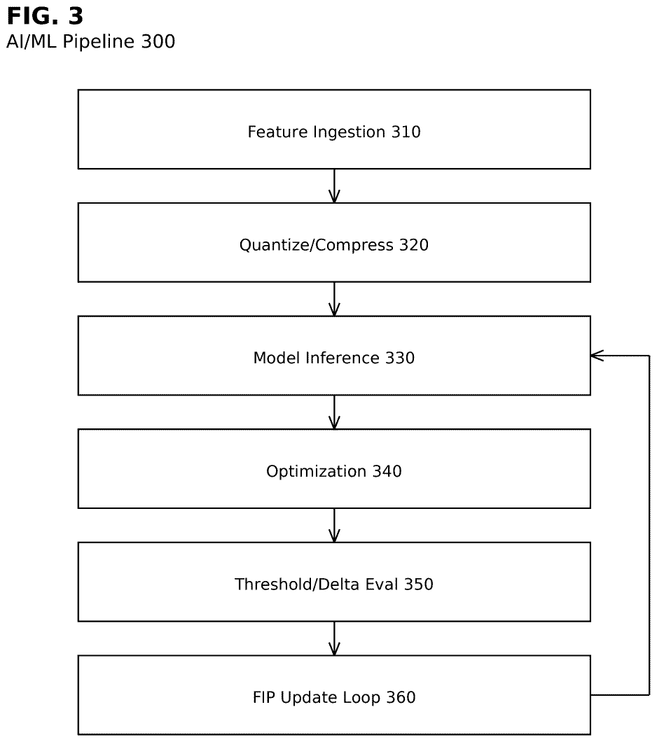

FIG. 4 illustrates an example candidate ownership-entity selection flow (400), including state intake (410), candidate retrieval (420), objective evaluation (430), ranking (440), and selection output (450).

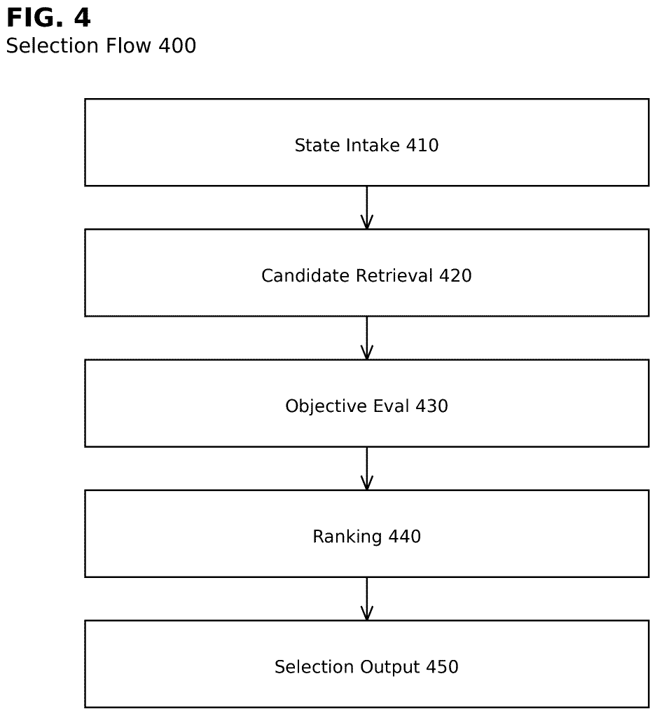

FIG. 5 illustrates an example multilateral netting graph (500) and optimization (530) producing a net settlement vector (540) and a Proof-of-Netting (PoN) receipt (550) for a clearing group comprising multiple participants (510, 520).

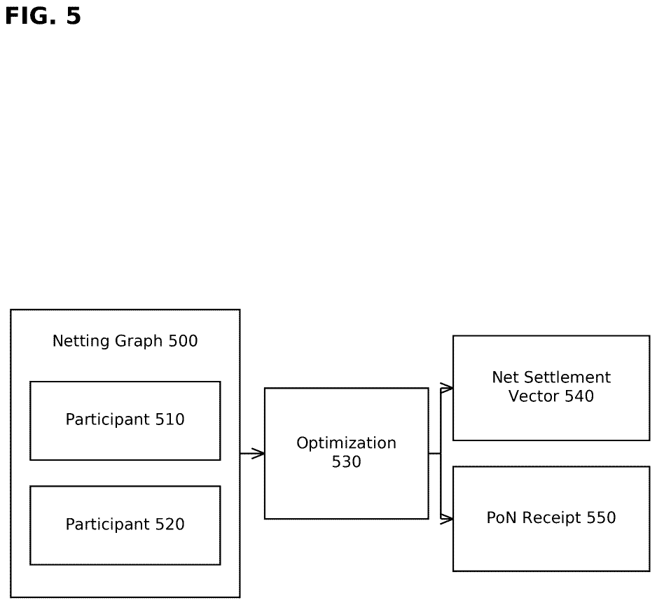

FIG. 6 illustrates an example atomic settlement group execution (600) across heterogeneous payment rails (610, 620), including lock/commit operations (630), rollback operations (640), rollback receipts (650), and a settlement manifest receipt (660).

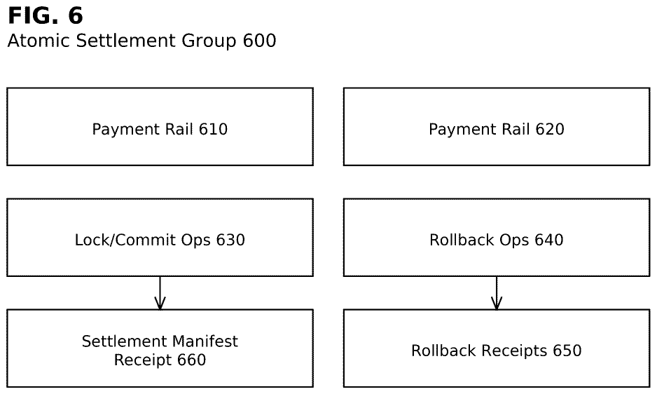

FIG. 7 illustrates an example jurisdictional parameter graph and rulepack lifecycle (700), including change-of-law ingestion (710), compilation (720), versioned deployment (730), and recompute triggers (740).

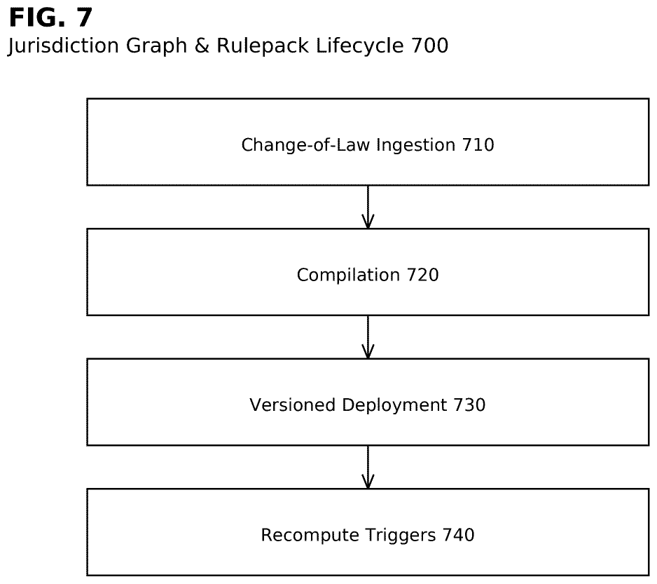

FIG. 8 illustrates an example lifecycle optimization sequence (800) including a trigger (810), one or more re-title events (820), continuity mechanisms (830), and surplus routing outputs (840).

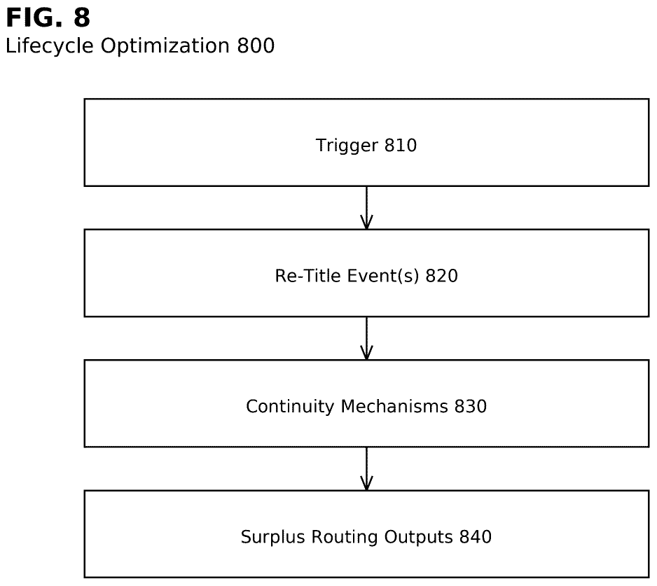

FIG. 9 illustrates an example workplace-benefits autopilot embodiment (900) including eligibility and constraints (910), internalized advances or funding actions (920), netting and repayment (930), and benefit/audit receipts (940).

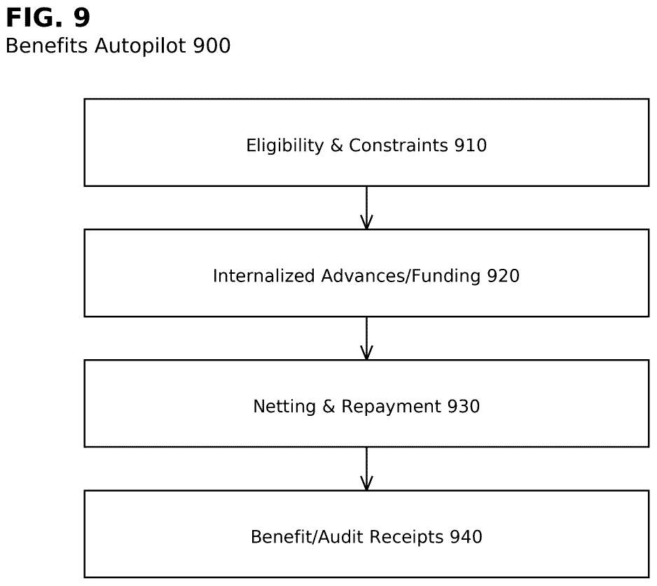

FIG. 10 illustrates an example labor and tax embodiment (1000) including task parcelization (1010), classification (1020), safe harbors/withholding (1030), and reporting and payments (1040).

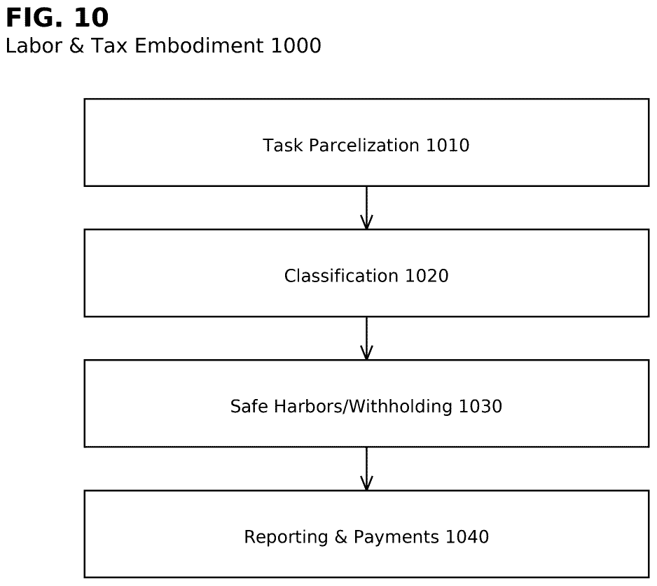

FIG. 11 illustrates an example nonprofit and philanthropic ownership-wrapper embodiment (1100), including wrapper selection (1110), governance controls (1120), and surplus routing and receipts (1130).

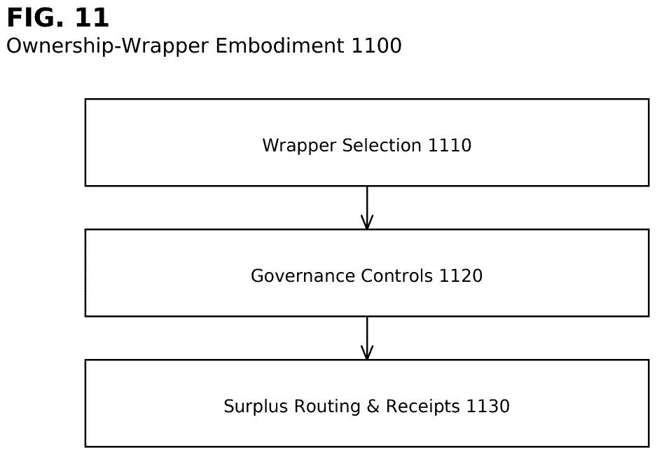

FIG. 12 illustrates an example privacy, security, and audit architecture (1200) including encrypted and redactable storage (1210), selective disclosure (1220), attestation/trusted execution environments (TEEs) (1230), and deterministic replay (1240).

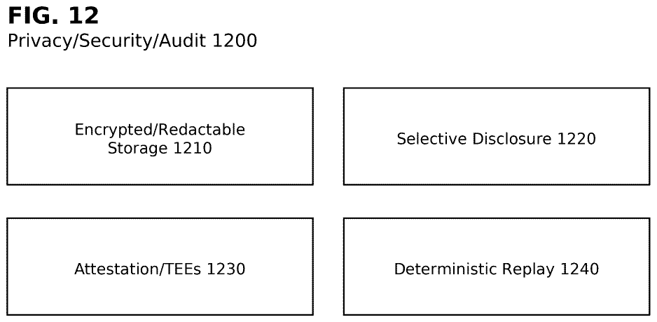

FIG. 13 illustrates an example credential plane (1300) including credential issuance (1310), verification (1320), status checking (1330), and selective-disclosure proofs (1340).

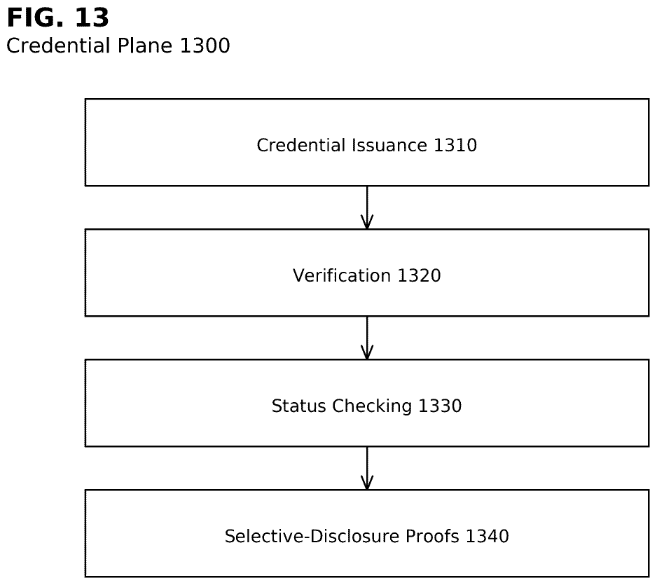

FIG. 14 illustrates an example time-fabric pipeline (1400) including normalize timestamps (1410), time labels (1420), timestamp tokens (1430), and event-order verification (1440).

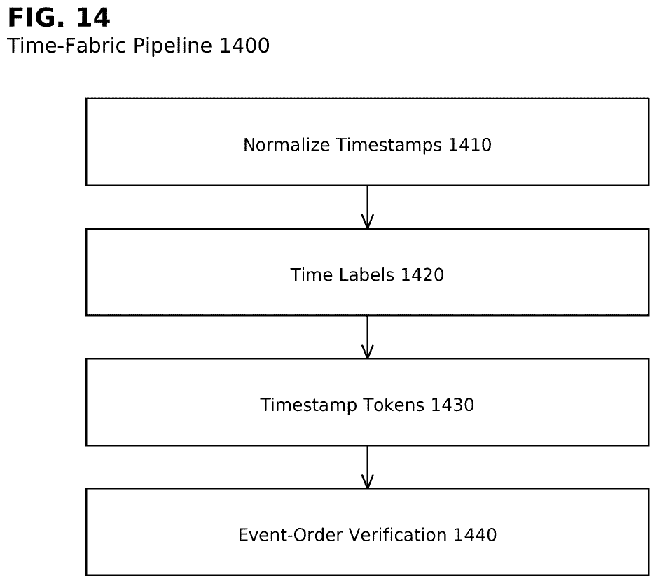

FIG. 15 illustrates an example opaque-to-transparent marketplace control plane (1500) including disclosure budgets (1510), commit/reveal controls (1520), predicate matching (1530), and usage-only tokens (1540).

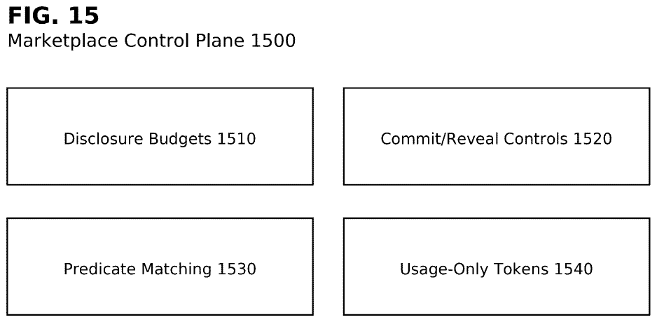

FIG. 16 illustrates an example predict-then-net pipeline (1600) including constraint assembly (1610), forecasting (1620), netting set formation (1630), pre-offset authorization (1640), and atomic group generation (1650).

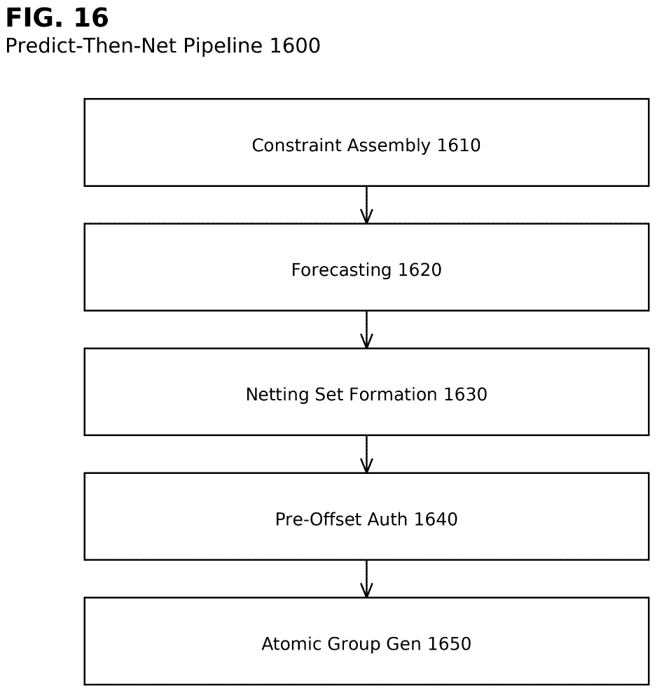

FIG. 17 illustrates an example AI exoskeleton control plane (1700) including deterministic mode (1710), guarded stochastic mode (1720), governance gates (1730), provenance tracking (1740), and human override and receipts (1750).

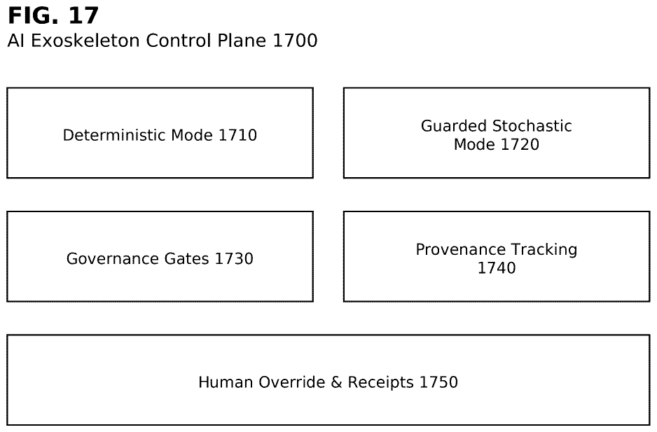

FIG. 18 illustrates an example surplus measurement and redistribution pipeline (1800) including surplus measurement (1810), distribution rules (1820), surplus pool accounting (1830), and controlled distributions (1840).

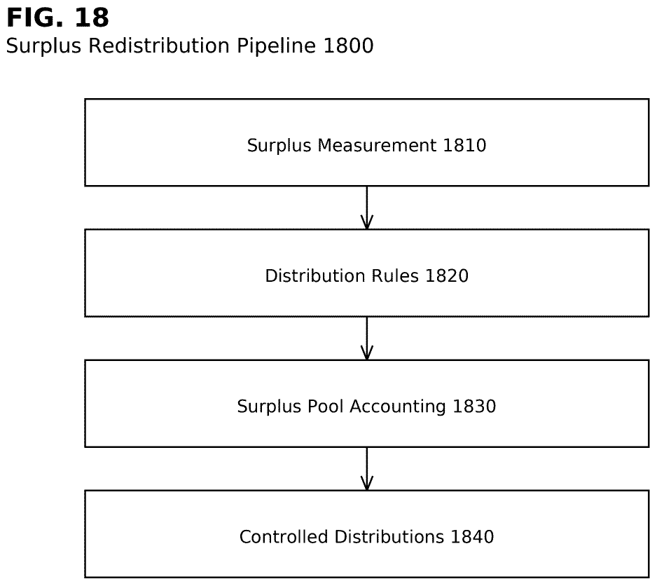

### DETAILED DESCRIPTION

Reference will now be made to the accompanying drawings and exemplary embodiments. The described embodiments are illustrative and not limiting. Variations, substitutions, and combinations of features may be made without departing from the scope of the claims.

Unless otherwise indicated, terms such as “coupled”, “connected”, and “communicatively coupled” include direct and indirect coupling. The term “or” is inclusive unless context indicates otherwise. A “set” may include one or more elements. “Based on” includes “based at least in part on”. “Configured to” includes “programmed to”.

### 1. Core Kernel and Repeatable Scaffold

In embodiments, the invention is organized around a single repeatable kernel that can be applied across many asset types, industries, and regulatory contexts. The kernel is implemented as a receipt-native, event-sourced optimization and actuation loop:
(1) predict: compute a most-efficient-use representation for an asset under current facts, constraints, and observed or declared usage;
(2) compare: compute an ownership-inefficiency differential between the predicted most-efficient-use representation and the current ownership and usage state;
(3) select: query an ownership-entity database to obtain a ranked list of specialized ownership entities, evaluate an objective function for expected collective economic benefit, and select an ownership entity;
(4) encode: generate transaction parameters that (i) transfer legal title or other ownership rights to the selected entity and (ii) preserve continuity of usage for one or more users through an enforceable usage-rights instrument;
(5) execute: execute the ownership transfer and usage-rights instrument, optionally together with related financial and policy actions (for example: benefit elections, deductions, remittances, and settlements) as an atomic settlement group;
(6) receipt: generate cryptographically verifiable receipts that bind inputs, policy versions, transaction parameters, and outcomes into an append-only event ledger; and
(7) repeat: re-run the loop over time as facts, policies, prices, or usage patterns change, including re-titling to newly selected entities without interrupting user access.

This “predict->compare->select->encode->execute->receipt->repeat” kernel is intentionally domain-agnostic. Domain specifics (for example: ESPP, payroll classification, ACA safe harbors, intercompany netting, nonprofit ownership wrappers, or token-rail settlement) are implemented as constrained embodiments that share the same kernel and receipt grammar.

In embodiments, the kernel achieves transaction compression and disintermediation by internalizing functions traditionally performed by intermediary actors (e.g., brokers, agents, recordkeepers, managers, payment processors, and other coordinating services) into a receipt-native, policy-gated execution layer. For example, rather than routing value through multiple staged transfers, reconciliations, and fee-bearing hops, the system computes a net settlement plan and executes an atomic settlement group across one or more rails, while producing cryptographically verifiable receipts that substitute for manual attestations. This reduces message volume, reduces intermediary hop count, and reduces attack surface, while improving auditability, determinism, and compliance evidence in regulated environments.

### 1.1 Technical Problem Framing and Computer-System Improvements

In conventional systems, ownership, eligibility, settlement, and audit evidence are fragmented across heterogeneous databases and third-party services. This fragmentation forces repeated cross-system queries, manual reconciliation, and duplicated record retention, increasing latency, storage overhead, and security exposure. Conventional systems also tend to generate large volumes of gross transactions (e.g., bilateral payments and reconciliations) and then rely on intermediaries and after-the-fact reports to explain outcomes.

Embodiments provide a technical solution that improves the operation of computing systems by (i) executing inference on hardware-accelerated and statically quantized neural-network representations to reduce memory bandwidth and inference latency; (ii) representing policy constraints as versioned rulepacks compiled into machine-evaluable predicate graphs to enable deterministic gating and targeted recomputation; (iii) compressing transaction execution by multilateral netting and atomic settlement groups that reduce message count, exception handling, and duplicated ledger entries; and (iv) producing cryptographically verifiable, typed receipts that enable deterministic replay, tamper detection, and selective disclosure. These improvements are implemented as concrete data structures (e.g., receipts, manifests, indices, and graph objects) and control loops (e.g.,

predict→compare→select→encode→execute→receipt→repeat), and they result in measurable reductions in computation, storage, and network activity while increasing auditability and security.

In some embodiments, the system further reduces storage and transmission cost by de-duplicating repeated proof artifacts and policy evidence across receipts (sometimes referred to herein as receipt-spine compression), enabling sub-linear growth of retained audit material while preserving stateless verification and deterministic replay. These and other improvements are described in greater detail below.

### 2. Definitions, Data Objects, and Receipt Vocabulary

Embodiments use a shared vocabulary of typed data objects, identifiers, and receipts (collectively, a “receipt vocabulary”) to enable the kernel to be applied repeatably across domains while preserving auditability and deterministic replay. Unless otherwise stated, objects are versioned, have stable identifiers, and are cryptographically bound to relevant inputs, outputs, constraints, and execution results via digests and/or signatures. Equivalent names, fields, encodings, or schemas may be used.

| Term | Exemplary meaning |
|---|---|
| Asset | Any tangible or intangible resource, right, |
| | entitlement, capacity slice, or economic |
| | opportunity capable of being modeled and |
| | optimized. Assets may include physical |
| | property, vehicles, equipment, intellectual |
| | property, financial entitlements, benefit rights, |
| | time/capacity, or contract rights. In some |
| | embodiments, an asset includes a unit of work |
| | or a right to a future flow. |
| User | A natural person or a legal entity that uses, |
| | controls, benefits from, or is associated with |
| | an asset. A user may be an individual, |
| | employee, household member, contractor, |
| | customer, beneficiary, or other participant. |
| Usage rights | A set of enforceable rights allowing a user to |
| | possess, access, operate, consume, or |
| | otherwise use an asset, independent of legal |
| | title. Usage rights may be expressed via |
| | leases, licenses, rentals, service contracts, |
| | access tokens, time-slice permissions, or other |
| | instruments. |
| Ownership entity/ | A legal entity selected to hold legal title or |
| Specialized entity | other ownership rights for an asset (e.g., LLC, |
| | trust, nonprofit, foundation, cooperative, SPV, |
| | benefit corporation, captive, or other |
| | structure), optionally with a governance and |
| | benefit-sharing arrangement. |
| Most-efficient-use | A machine-generated representation of |
| vector | predicted efficient uses of the asset, which |
| | may include a ranked list of uses, a |
| | probability distribution, an allocation vector, |
| | or a state/action plan. |
| Collective economic | A measurable objective function representing |
| benefit | expected outcomes across one or more |
| | stakeholders. Examples include net costs |
| | avoided, returns captured, fees avoided, risk |
| | reduced, taxes optimized, utilization |
| | improved, or combinations thereof, subject to |
| | constraints. |
| Receipt | A typed, structured digital record that binds |
| | inputs, policy versions, computations, and |
| | outcomes, and is cryptographically protected |
| | and stored in an append-only event ledger. |
| Rulepack | A versioned, jurisdiction-specific bundle of |
| | rules, tests, factors, and thresholds used to |
| | enforce policy constraints (for example: labor |
| | classification or tax rules). In embodiments, a |
| | receipt binds the rulepack identifier and a |
| | cryptographic hash of the rulepack version |
| | used for the decision. |
| Unit of work | A smallest compensable work element with a |
| | unique identifier and descriptor (time, scope, |
| | role, jurisdiction). A unit of work may be |
| | represented as a node in a task DAG and can |
| | be separately classified and settled. |
| Pay cycle/Settlement | A discrete settlement period (for example, a |
| cycle | payroll period) identified by a period |
| | identifier used for aggregation, netting, and |
| | receipt linkage. |
| Settlement | A deterministic reference that links settlement |
| identifier | legs and receipts for a cycle. In embodiments, |
| | a settlement identifier is propagated through |
| | payment messages as end-to-end identifiers |
| | and preserved unchanged across the chain. |
| Multilateral | An optimization that offsets reciprocal |
| netting | obligations across a consented clearing group |
| | to minimize gross settlement volume, subject |
| | to legal and policy constraints (for example: |
| | setoff rights). |
| Proof-of-Netting | A receipt that binds gross obligation vectors, |
| (PoN) | offsets applied, exclusions, and correlation |
| | identifiers and produces a net settlement |
| | vector for a settlement cycle. |
| Proof-of-Benefit | A receipt that binds benefit-related actions or |
| (PoB) | allocations (for example: an ESPP purchase, |
| | employer match capture, premium allocation, |
| | or hierarchy-of-needs allocation) to the |
| | originating settlement cycle and the governing |
| | rules. |
| Proof-of-Classification | A receipt that binds a work unit or asset to a |
| (PoC) | classification under a specific rulepack and |
| | records evidence, factors, and a rationale |
| | sufficient to support audit and deterministic |
| | reconstruction. |
| Trust coefficient | A computed reliability or trust score derived |
| | from evidence-rich receipts and settlement |
| | behavior, used to adjust access tiers, reserves, |
| | premiums, collateral, or selection weights. |

Asset: A resource, entitlement, or right subject to allocation and/or optimization. Assets may be tangible or intangible and may include non-transferable or transfer-restricted entitlements (e.g., plan entitlements) that are treated as constrained variables in the objective function.
Specialized entity/ownership entity: An entity record eligible to take title or other ownership rights for an asset, where the entity record is stored in an ownership-entity database and is characterized by attributes used for selection and constraint checking. In embodiments, the entity record includes one or more of: entity_id; jurisdiction; entity_type; governance constraints; eligible asset classes; usage-rights patterns supported; custody/recordation endpoints; tax or accounting posture; risk buffers/reserve requirements; applicable policy bindings (rulepack_id and rulepack_hash); and interfaces/connectors used during selection and execution. In some embodiments, ownership entities include, without limitation, natural persons; for-profit business entities (e.g., corporations, LLCs, partnerships); nonprofit or cooperative entities; trusts or special-purpose vehicles; foundation-owned or public-benefit structures; and/or governmental or quasi-governmental entities where permissible.
Ownership-from-usage detachment: A configuration in which title or ownership interest is assigned to a selected entity while continuity of user access, possession, or consumption is preserved through an enforceable usage-rights instrument.
Most-efficient-use vector: A computed representation of predicted outcomes and utilization under candidate ownership and usage configurations. In embodiments, the most-efficient-use vector comprises one or more fields and/or dimensions such as predicted return, predicted cost, risk score, liquidity score, compliance score, and/or efficiency indicators associated with transaction compression (e.g., predicted reduction in settlement legs or message count), and may further include confidence values or uncertainty bounds. The representation may be a vector, embedding, probability distribution, or other structured output used for ranking and thresholding.
Ownership-inefficiency differential: A computed difference (or vector difference) between (i) a predicted most-efficient-use representation for an asset under current facts, prices, and policy constraints, and (ii) a declared, observed, or current ownership configuration and usage posture. In embodiments, the differential may be expressed as a scalar score, a multi-dimensional delta vector, or a set of constraint violations and cost deltas. In embodiments, when the differential meets or exceeds a threshold (e.g., a threshold ownership-inefficiency value), the system triggers or schedules one or more actions, including entity selection, reallocation, netting, transaction parameter encoding, and receipt issuance.
Collective economic benefit objective function: A machine-evaluable objective function J(⋅) used to rank candidate ownership entities and/or candidate execution plans, where J(⋅) combines multiple measurable components into a single score subject to policy constraints. In a non-limiting example, J(e,plan)=Σ_k w_k·m_k(e,plan)−Σ_j λ_j·penalty_j(e,plan), where each m_k is a normalized metric (e.g., gross-to-net reduction, fees avoided, latency reduction, reduction in exception-handling rate, reduction in storage/transmission cost via receipt-spine compression, predicted compliance satisfaction, and risk reduction), and penalty terms encode hard or soft violations of constraints (e.g., prohibited transfers, segregation requirements, minimum net-pay floors, privacy budgets, or consent requirements). The weights w_k and penalty coefficients λ_j may be policy-configurable and versioned in rulepacks, and the evaluated components and selected maximizer are bound into selection receipts.
Title-transfer routine: A repeatable procedure that encodes and executes transfer of title or ownership interest (or another legally cognizable ownership attribute) to a selected entity, together with usage-rights preservation and receipt issuance.
Clearing group: A set of participants whose obligations and entitlements are evaluated for eligibility and then netted within a settlement cycle under applicable constraints.
Obligation ledger: A data structure recording obligations, entitlements, and policy tags as vectors/entries keyed by participant identifiers, period identifiers, and/or settlement identifiers.
Settlement cycle/settlement_id: A discrete period or cycle in which obligations are evaluated, netted, and settled, identified by a unique settlement_id and time bounds (e.g., payroll cycle, invoice cycle, benefits cycle).
Receipt bundle: A cryptographically verifiable package of one or more typed receipts for a kernel execution and/or settlement cycle, including digests of key inputs/outputs, policy references, timestamps, and correlation identifiers.
Append-only event ledger: A tamper-evident ledger storing receipt bundles and/or receipt digests in an append-only sequence, optionally hash-linked (e.g., Merkle chaining) to support deterministic replay and audit.
Proof-of-Netting (PoN): A receipt type that binds gross obligation vectors, offset vectors, excluded obligations, and the resulting net settlement vector for a settlement cycle, together with eligibility constraints and identifiers. In some embodiments, the PoN also encodes (i) an exclusion mask aligned to the gross obligation vector that identifies gross obligations disallowed by a rulepack (e.g., by setoff-right or segregation constraints) and (ii) for each excluded obligation, a reason code identifying a policy node of a setoff policy matrix (or an equivalent rulepack predicate graph) that caused the exclusion.
Net settlement vector/netting vector: A mapping or vector produced by a multilateral netting engine that specifies, for a settlement cycle, a net payable or net receivable amount per participant (and/or per account/rail) after applying offsets and exclusions under policy constraints. In embodiments, the system computes compression metrics relative to a baseline gross-obligation graph (e.g., transaction-count reduction, message-count reduction, and/or notional reduction), and binds such metrics into a Proof-of-Netting (PoN) receipt for audit and replay. In embodiments, netting is performed subject to conservation-of-value constraints per clearing-group participant (preserving each participant's net position) and may compute an offset vector together with an exclusion mask and associated reason codes that bind excluded obligations to the rulepack constraint that caused exclusion.
Proof-of-Classification (PoC): A receipt type that binds a classification result (e.g., labor/tax classification) to the rulepack identifier and hash used, evidence inputs, and a rationale artifact.
Proof-of-Benefit (PoB): A receipt type that binds benefit-related actions (e.g., advances, purchases, contributions, distributions) to originating receipts and a settlement cycle, enabling attribution and audit.
Rulepack: A compiled, versioned, jurisdiction-scoped set of computable rules, thresholds, and tests derived from a policy lattice; identified by rulepack_id and a rulepack hash and used as constraints during selection and execution. In some embodiments, a rulepack includes a setoff policy matrix (or predicate graph) encoding netting and setoff permissions and exclusion rules; each entry/node may be identified by a policy node identifier that is emitted as a reason code in receipts to explain why an obligation was excluded from netting.
Governance pack: A versioned control bundle specifying permitted autonomy, disclosure controls, drift thresholds, audit requirements, and human override policies applicable to a jurisdiction, plan, participant class, or product configuration.
Atomic settlement group: A group of settlement legs executed with coordinated commit/compensate behavior such that partial execution is prevented or remediated, preserving end-to-end identifiers across heterogeneous rails.
Correlation identifier: An identifier used to bind and trace related events, receipts, and settlement legs across modules and external systems (e.g., an ISO 20022 EndToEndId or an equivalent end-to-end identifier).
Benefit-sharing parameter: A parameter that specifies how measured surplus or savings is redistributed among stakeholders (e.g., user, nonprofit, cooperative pool, reserve, regenerative routing).
Surplus: A measured improvement attributable to the kernel (e.g., reduced fees, reduced settlement volume, reduced failures, improved utilization) that is computed and optionally routed according to benefit-sharing parameters.
Deterministic replay: A capability to re-run the kernel for a given receipt bundle and verify outputs and compliance outcomes using stored inputs, policy references, and execution artifacts.
Intermediary function: A function, service, or role that mediates between participants and value/rights flows and that can introduce additional message hops, fees, latency, or attack surface (e.g., brokering, recordkeeping, underwriting, custody, settlement routing, compliance verification, tax filing, or administrative coordination). In embodiments, intermediary functions are modeled as policy modules with measurable leakage, risk, and compliance overhead and may be internalized, partially internalized, or retired by the platform.
Interdependence Index (IIndex): A dimensionless scalar (e.g., in [0,1]) computed for a network, cohort, or intermediary function from normalized technical and economic metrics (e.g., cross-employer task reuse, credential portability utilization, multilateral netting density, surplus-to-fee ratio, and/or fragility/concentration). The IIndex is used as an input to control logic that triggers intermediary internalization, routing changes, and automation-level gating.
Intermediary internalization controller: A software-implemented control component executed by one or more processors that reads interdependence metrics (including IIndex), externalization profiles, and policy thresholds, maintains an internalization state for one or more intermediary functions (e.g., {External, Hybrid, Internalized, Retired}), and drives transitions and routing changes while emitting verifiable receipts.
TransitionReceipt (SunsetRecord): A receipt that records a state transition for an intermediary function, including at least a prior state, a new state, metric snapshots (e.g., IIndex, leakage/fee-load, risk score, compliance cost), policy bindings (rulepack identifiers/hashes), affected flow identifiers, and rollback criteria or safe-mode conditions.
CompressionOpportunityReceipt (CompressionProposalReceipt): A receipt that records identification of a candidate transaction-compression or disintermediation action, including baseline gross-flow descriptors, a candidate compressed plan (e.g., a net settlement vector, routing change, or internalized module), predicted savings (e.g., message-count reduction, fee displacement, latency reduction), and feasibility proofs under applicable policy constraints.
CompressionExecutionReceipt (Proof-of-Compression): A receipt that binds an executed compression action to before/after state roots, included obligations, offsets applied, legs removed or internalized, settlement identifiers, and any exceptions, enabling later proof that gross flows were compressed into fewer, auditable net executions.
AssetParcel/AssetParcelReceipt: A data object and receipt that represent parcelization of an asset into one or more granular rights components (e.g., title, usage, cash-flow, risk/insurance, tax attributes, regulatory entitlements, or time-windowed penalty/credit opportunities), including parcel identifiers and linkages to the originating asset_id and to downstream wrapper bindings.
WrapperEvaluationReceipt/WrapperBindingReceipt: Receipts that record evaluation of candidate legal/tax/ownership wrappers for one or more AssetParcels under the policy lattice (including which wrappers were pruned, which constraints were satisfied, and objective-function values), and record binding of a selected wrapper and ownership entity to a parcel, including rulepack proofs and deterministic before/after state roots. In embodiments, a WrapperRebindingReceipt records subsequent wrapper changes over time.
PoolContainer/PoolActivationReceipt: A container object and receipt that represent a pooled resource (e.g., pooled capital, pooled underwriting, pooled entitlements, or pooled surplus) with participant membership, segregation constraints, and activation thresholds; a PoolActivationReceipt records activation of pooling when a threshold is met (e.g., scale, reserve coverage, risk diversification) and a PoolCancellationReceipt records deactivation or unwind.
Receipt-spine compression: A mechanism for reducing storage and transmission overhead of a large receipt ledger by content-addressing and de-duplicating shared proof artifacts (e.g., repeated policy proofs, timestamp tokens, credential manifests) across receipts, while preserving stateless verification and deterministic replay.

### 2.1 Identity and Credential Objects

Verifiable credential (VC): In embodiments, a digitally signed, machine-readable credential that asserts one or more claims about a subject (e.g., eligibility, role, consent, plan limit, credentialed skill, or delegation). A VC may include an issuer identifier, a subject identifier (e.g., a decentralized identifier (DID) or account identifier), one or more claim fields, and a signature. A verifier can validate a VC by verifying the issuer signature and checking the VC's status.

Credential status list: In embodiments, a revocation or suspension data structure referenced by a VC that enables a verifier to determine whether the VC is currently valid. A status list may be implemented as a bitstring, sparse list, accumulator, or other structure that supports efficient status checks and auditable status changes. Status list updates may emit StatusReceipt events that are hash-linked into the append-only event ledger.

Selective disclosure proof: In embodiments, a cryptographic proof that discloses only a subset of VC fields or proves satisfaction of a predicate without revealing underlying values (e.g., proving “age≥18” or “affordability satisfied” without disclosing the exact age or wage).

Selective-disclosure events may be logged as RevealReceipts referencing a disclosure budget. Decentralized identifier (DID): In embodiments, a globally unique identifier used to represent a participant, entity, or component and to bind receipts and credentials without requiring disclosure of personally identifiable information. DIDs may resolve to public keys, service endpoints, or verification methods used for signature validation.

### 2.2 Container Objects, Usage Tokens, and Disclosure Budgets

Virtual asset container (VAC): In embodiments, a structured object that encapsulates an asset or capacity slice (e.g., an appointment window, compute time-slice, vehicle time slot, benefit seat, or usage entitlement) as usage rights with constraints, including availability windows, pricing policy, safety constraints, revocation pointers, and disclosure budgets.

Offer/task container (OTC): In embodiments, a structured object representing demand, requirements, and guardrails for a desired asset use or unit of work. An OTC may specify predicates (e.g., “licensed CPA”), acceptable windows, price bands, fairness constraints, and a disclosure budget for the requester.

Usage-only token (UOT): In embodiments, a token, ticket, lease right, or other transferable instrument that conveys a bounded right to use an asset (or to receive an outcome) without conveying legal title. A UOT may be issued after a match or allocation decision and may be redeemed or enforced by the system to preserve continuity of usage under ownership-from-usage detachment.

Disclosure budget: In embodiments, a policy object that limits what information may be disclosed, to whom, and at what stage of a workflow (e.g., before commit vs. after commit). Disclosure budgets support opaque-to-transparent workflows where matching occurs on predicates and proofs and identity is revealed only after commitment.

Container receipt: In embodiments, a typed receipt binding a container identifier (e.g., VAC_id or OTC id), policy hashes, validity windows, and disclosure budgets to enable verifiable propagation of container terms across networks.

### 2.3 Work Atomization and Taskoids

Unit of work/taskoid: In embodiments, the smallest compensable or classifiable work element, identified by a work_id, with associated descriptors such as time, scope, role, jurisdiction, and deliverable. Each unit of work may be evaluated under one or more rulepacks and may emit a Proof-of-Classification (PoC) receipt binding {work_id, jurisdiction, rulepack_id, rulepack_hash}.

### 2.4 Idempotency, Canonicalization, and Timestamp Tokens

Idempotency key: In embodiments, an identifier used to ensure that a command (e.g., issuance of a payment instruction or a receipt bundle) can be safely retried without duplicating effects. Idempotency keys may be derived from a settlement_id, correlation identifier, and operation type.

Canonical serialization: In embodiments, a deterministic encoding procedure for receipts and evidence objects (e.g., canonical JSON, CBOR canonical form, or other deterministic encoding) such that cryptographic hashes and signatures are stable across implementations.

Timestamp token: In embodiments, a cryptographic timestamp or time attestation that binds a receipt bundle or ledger checkpoint to a time anchor, enabling order-of-events verification and audit. Timestamp tokens may be generated by a trusted timestamping service, a secure enclave clock, or other trusted time source and stored in the event ledger.

Exactly-once execution receipts: In some embodiments, the platform enforces exactly-once semantics for state transitions that span multiple subsystems or external rails by using idempotency keys together with a two-phase commit protocol. For example, the platform may (i) prepare payment instructions across selected rails, (ii) verify that all preparations succeed, and (iii) commit the grouped execution while emitting an ExactlyOnceReceipt with an EXECUTE outcome and an outcomeDigest. If a duplicate request is detected or a preparation fails, the platform emits an ExactlyOnceReceipt with a DEDUP or ABORT outcome and does not re-execute side effects. These receipts enable deterministic replay and eliminate double-spend or duplicate-settlement failure modes.

### 3. System Architecture Overview

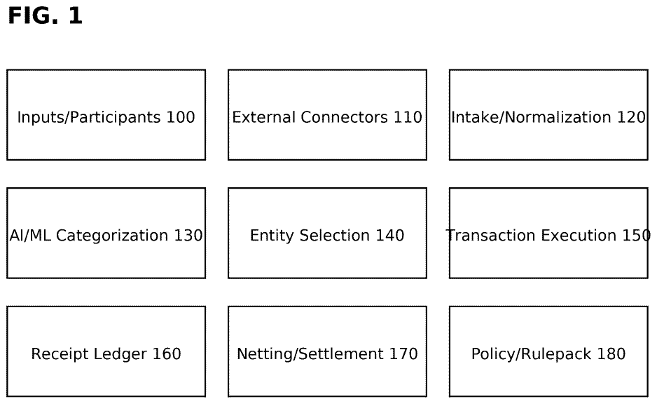

FIG. 1 illustrates an example computing environment implementing the invention. In embodiments, the system includes at least one computer system having one or more processors and a memory storing executable instructions. The system may be implemented as a cloud-based platform, a hybrid cloud plus on-premises deployment, an edge appliance synchronized with a cloud service, or a distributed peer-to-peer network with trusted execution environments.

In embodiments, the computer system includes functional modules, which may be implemented as software components, microservices, containers, hardware accelerators, or combinations thereof. Example modules include:
(a) an intake and normalization module that receives information about a user and an asset, ingests asset-utilization transaction data, and retrieves supplemental datasets of economic outcomes;
(b) an AI/ML categorization engine, optionally accelerated by an ASIC, that predicts a most-efficient-use vector for the asset, including predicted outcomes under candidate ownership and usage configurations;
(c) an ownership-entity database and selection engine that stores candidate specialized ownership entities and evaluates an objective function for expected collective economic benefit to select a top-ranked entity;
(d) a transaction encoding and execution engine that generates a conveyance record and a usage-rights record, executes legal title transfer while preserving usage rights for the user, and stores executed records;
(e) a receipt generation engine and append-only event ledger that emits typed receipts, cryptographically links receipt digests, and enables deterministic replay and audit;
(f) a multilateral netting and settlement engine that computes netting sets for a consented clearing group, generates payment instructions, and executes an atomic settlement group across heterogeneous rails; and
(g) a policy and rulepack subsystem, optionally implemented as a jurisdictional parameter graph and change-of-law compiler, that supplies versioned constraints and governance packs and triggers targeted recomputation when rules or facts change.

In embodiments, the modules share a common receipt grammar and common identifiers (asset_id, user_id, entity_id, period_id, settlement_id, rulepack_id, and receipt ids), enabling end-to-end traceability across lifecycle events.

### 3.1 Planes, Connectors, and Event Sourcing

In embodiments, the system is implemented as an event-sourced architecture comprising a set of services coupled by an event bus and one or more append-only logs. Each kernel step (predict, compare, select, encode, execute) emits a typed receipt that is written to an append-only event ledger and also published as an event to downstream consumers. This enables deterministic replay, incremental recomputation, and audit reconstruction from receipts rather than from mutable state alone.

In embodiments, external systems are integrated through connector adapters, including connectors to payroll processors, benefit administrators, recordkeepers, brokers/custodians, banking systems, enterprise resource planning (ERP) systems, tax remittance systems, and token or distributed-ledger networks. Connectors may translate external events into canonical obligation entries and may translate kernel outputs into rail-specific instructions (e.g., payment messages, brokerage order messages, benefit election updates).

### 3.2 Credential Plane and Eligibility Evidence

In embodiments, a credential plane issues, verifies, and revokes credentials used by the kernel. For example, eligibility and plan-limit evidence for workplace benefits, role and classification evidence for labor/tax, and consent evidence for netting may each be represented as verifiable credentials. A credential verification service may resolve issuer keys (e.g., via DID resolution), validate signatures, consult status lists, and emit CredentialVerificationReceipts that are referenced by downstream PoB/PoC/PoN receipts.

### 3.3 Time Fabric and Period Normalization

In embodiments, a time fabric normalizes event timestamps and disparate accounting calendars into canonical period identifiers and settlement identifiers. For example, a payroll cycle, benefit offering window, and tax deposit schedule may each have distinct time bases. The time fabric labels events with one or more period identifiers, generates time anchors (e.g., timestamp tokens) at period boundaries, and enables netting and audit processes that require consistent order-of-events across systems.

### 3.4 Predict-then-Net Engine and Settlement Orchestration

In embodiments, a predict-then-net engine performs forward simulation to forecast upcoming obligations and opportunities for offset. Using these predictions and rulepack constraints, the engine forms candidate netting sets and produces pre-offset authorizations that can be executed by a settlement orchestrator. The settlement orchestrator groups legs into atomic settlement groups, executes them across one or more rails, and issues settlement manifests and Proof-of-Netting receipts binding the gross and net vectors, execution identifiers, and any compensating actions.

### 3.5 Opaque-to-Transparent Marketplace Adapter

In embodiments, an opaque-to-transparent adapter supports allocation and matching workflows where sensitive attributes are withheld until commitment. Supply may be represented as VACs and demand as OTCs. Matching may occur on predicates and proofs under disclosure budgets, and after commit the adapter may reveal only the minimally necessary information, issuing RevealReceipts and updating trust coefficients based on objective and subjective completion evidence.

### 3.5.1 Reverse-Auction “Carousel” and Time-Fabric Scheduling (Optional)

In some embodiments, the opaque-to-transparent adapter includes a reverse-auction rail that implements a falling-price “carousel” for virtual asset containers (VACs) and/or hybrid value containers (HVCs). Rather than posting a single fixed price, a sponsor expresses a descending price schedule and an optional disclosure schedule. The reverse auction is represented as explicit data structures on a future-rail planning ledger and is driven by the time fabric so that each ladder step is eligible to execute at a verifiable time anchor.

In one non-limiting implementation, each reverse auction is modeled as an AuctionBlock entry including fields such as {auction_id, vac ref, stepSchedule[ ], disclosureSchedule[ ], policyBundleRef, state}. The stepSchedule includes AuctionStep records with a normalized trigger tick (e.g., a period boundary), a step_price, and optional capacity. The disclosureSchedule coordinates controlled reveal under disclosure budgets (e.g., early steps evaluate coarse predicates; later steps reveal richer attributes) and is anchored to timestamp tokens for auditability.

Participants subscribe to the auction by submitting Offer/Task Containers that express acceptance predicates and (in some embodiments) commit-hashed private reservation policies (opaque offers). The platform emits receipts including ReverseAuctionInitReceipts, AuctionJoinReceipts, ReverseAuctionEligibilityReceipts, AuctionStepReceipts, AuctionCloseReceipts, and AuctionAbortReceipts, and wires successful matches into the atomic settlement and netting pipeline via settlement manifests and settlement receipts. This configuration preserves bid privacy until a clearing condition is met while maintaining deterministic replay and receipt-backed auditability of scheduling and matching decisions.

### 3.6 Deployment and Scaling Options

In embodiments, the system is deployed as one or more cloud services, on-premises appliances, edge nodes, or hybrid deployments. For example, a payroll/benefits employer may operate a local node that signs receipts and performs credential verification, while a centralized service performs optimization and netting across clearing groups. Components may be horizontally scaled, and read-heavy receipt verification may be accelerated using replicated receipt indices and Merkle proofs.

### 4. AI/ML Categorization Engine and Hardware Acceleration

### 4.1 Input Datasets and Feature Generation

In embodiments, the system ingests asset-utilization transaction data for a user-asset pair. The transaction data may include, without limitation: sale events, lease events, rental events, usage telemetry, access logs, maintenance events, insurance events, tax events, payroll events, benefit events, entitlement events, and user profile records. The system may further retrieve supplemental historical datasets of economic outcomes and demographics (e.g., default rates, utilization distributions, price histories, policy outcomes, and cohort-level outcomes). In some embodiments, the asset-utilization transaction data includes business sale transaction information (e.g., records of sales, purchases, acquisitions, dispositions, and other conveyance events), and related ownership-structure information, which may be featurized along with usage telemetry and outcome variables.

The ingestion pipeline may normalize heterogeneous source formats into a canonical schema, compute derived features (for example: utilization rates, volatility measures, policy coverage predicates, and risk measures), and partition the resulting dataset into time-sliced windows keyed to period identifiers. In embodiments, the system performs privacy-preserving feature extraction, including hashing, tokenization, selective disclosure predicates, or encryption of sensitive fields.

### 4.2 Neural Network Representation, Quantization, and Inference

In embodiments, the categorization engine is implemented as an artificial neural network. The network may ingest the canonical feature representation and output a most-efficient-use vector. The most-efficient-use vector may be represented as: (i) a ranked list of candidate use/ownership configurations, (ii) a probability distribution over configurations, (iii) an allocation vector over possible uses, or (iv) an action plan that includes a recommended ownership entity and transaction parameters.

In some embodiments, network weights and network activations are represented during training and/or inference as 32-bit floating-point variables. In some embodiments, the system statically quantizes network weights and network activations as 8-bit integers to reduce storage footprint and improve inference throughput. Static quantization may include, for example, computing per-layer or per-channel scaling factors, clamping to an 8-bit range, and storing scale and zero-point parameters in memory alongside the quantized tensors. Quantization may be applied to weights, activations, or both, and may be configured such that weights are quantized at minimum to reduce memory footprint, while activations are quantized to reduce compute and memory bandwidth.

### 4.3 ASIC Neural Network Accelerator

In some embodiments, the categorization engine executes on an application-specific integrated circuit (ASIC) for an artificial neural network connected to memory. The ASIC may include an array of neurons, in which each neuron includes a register, a processing element, and one or more inputs. Synaptic circuits may include memories storing synaptic weights and coupling neurons. Hidden intermediate layers may include neurons that perform weighted calculations to identify patterns, correlations, and relationships within input data. Activation functions may include rectified linear unit (ReLU) and sigmoid functions to model nonlinear relationships.

The ASIC may incorporate on-chip SRAM, tensor cores, multiply-accumulate arrays, or other accelerators configured to execute quantized int8 operations efficiently. In embodiments, the ASIC performs inference over quantized weights and activations by applying scaling factors, performing integer MAC operations, and dequantizing (or partially dequantizing) intermediate outputs where needed. In some embodiments, the ASIC provides secure memory isolation and supports execution within a trusted environment for sensitive financial and identity data.

### 4.4 Training, Supervision, and Loss Functions

In embodiments, the categorization engine is trained using supervised learning. Labeled datasets with known inputs and desired outputs are fed into the network. The network may adjust internal weights using backpropagation and a loss function (for example: mean squared error, cross-entropy, or composite losses). In embodiments, the ASIC or a coupled training engine iteratively refines predictions until an error rate falls below a predefined threshold, enabling accurate predictions on new, unseen data.

In some embodiments, the system trains on historical datasets that include parameters for asset usage, ownership structures, and economic outcomes. The outputs may be trained to predict: expected net benefit under a given ownership structure, default probabilities, cost-of-capital, compliance risk, tax outcomes, utilization gains, or other measurable outcomes used in the objective function.

### 4.5 Functionally Invariant Path (FIP) Updates and Sparsity

In embodiments, the ASIC executes a functionally invariant path (FIP) algorithm that updates network weights along differential-geometry paths so as to preserve learned behavior while increasing sparsity. In some embodiments, the FIP algorithm updates weights using constrained optimization in weight space (for example: minimizing a distance metric subject to preserving function outputs within a tolerance). The resulting sparsity may improve inference efficiency and may reduce storage and bandwidth requirements. In embodiments, FIP updates are applied to newly accumulated asset-utilization transaction data to refine prediction accuracy while preserving prior knowledge.

In some embodiments, the FIP update loop is configured for continual learning in which new asset-utilization data arrives over time and the model is updated without catastrophic forgetting. For example, the system may (i) compute, from prior tasks or prior periods, an importance measure for each parameter (e.g., via gradients, Fisher-information approximations, or sensitivity measures); (ii) define a penalty term that increases as updated parameter values deviate from prior values for parameters having importance above a threshold; (iii) optimize a combined objective for a new task or new period that includes a prediction loss term plus the penalty term; and (iv) selectively increase sparsity by pruning or quantizing parameters that fall below importance thresholds. These operations can reduce storage and update complexity, preserve performance on prior distributions, and maintain stable behavior across cycles.

### Illustrative FIP Update Pseudocode (Non-Limiting):

inputs: prior_params θ0, importance w, new_data D

$$loss\_new = L ( θ , D )$$

$$penalty = \sum \_i w\_i * ( θ\_i - θ0\_i ) \hat{} 2$$

$${θ}^{*} = arg min\_θ ( loss\_new + λ * penalty )$$

apply sparsification/pruning to low-importance parameters; update θ0←θ*

### 4.6 Distributed Storage, Shard Migration, and Latency/Cost Heuristics

In embodiments, the system operates across distributed memory devices and geospatial data centers. The system may partition datasets into shards and migrate dataset shards between distributed memory devices based on a latency or cost heuristic. The heuristic may consider query latency, compute locality, network congestion, data residency requirements, or storage costs. Shard migration may include caching frequently accessed data, prefetching anticipated data, and maintaining consistency through versioned digests stored in receipts. These techniques can sustain parallel, low-latency access for high-volume inference and settlement cycles.

### 4.7 Quantization, Mixed Precision, and Model Compression Alternatives

In embodiments, static quantization is performed using a calibration procedure that determines a scale factor and optional zero-point for each tensor or channel. For a real-valued tensor element x, an example affine quantization maps to an integer q as: q=clamp(round(x/scale)+zero_point, qmin, qmax). Dequantization reconstructs an approximate value \hat{x}=(q−zero_point)*scale. The system may apply per-tensor or per-channel scales, symmetric or asymmetric quantization, and may quantize weights, activations, or both. Quantization parameters (scale, zero_point, calibration ranges) may be recorded in a ModelCompressionReceipt and referenced by subsequent PoN/PoB/PoC receipts that depend on the model output.

In embodiments, the system uses mixed-precision inference where selected layers (e.g., attention layers, output layers, or calibration-sensitive layers) remain in higher precision while other layers are quantized. In some embodiments, the system applies additional compression, including pruning, structured sparsity, knowledge distillation, low-rank factorization, or parameter sharing. These compression steps reduce memory bandwidth and compute and can be reflected as measurable “surplus” captured by the surplus measurement module.

### 4.8 Continual Learning Safeguards and Anti-Forgetting Receipts

In embodiments, the categorization engine updates models over time as new asset-utilization transaction data is ingested. The functionally-invariant-path (FIP) algorithm may update weights along a constrained path that maintains functional output similarity for previously learned inputs while adjusting weights for new data. In some embodiments, the system computes a functional distance metric between outputs of a prior model version and a candidate updated model (e.g., on a validation set or on a replay buffer) and only commits the updated model if the functional distance is within a threshold. A ModelUpdateReceipt may bind: prior_model_hash, new_model_hash, training_data_window identifiers, functional-distance metrics, calibration parameters, and the FIP path identifier.

In embodiments, the system maintains a replay buffer or exemplar store for previously observed conditions and uses it to validate that updates preserve accuracy for “known” regimes. Where drift or uncertainty is detected, the system may gate the model output using a confidence threshold (e.g., conformal prediction interval coverage) and may fall back to deterministic rules or require a human override. Such gating decisions may emit AIGatingReceipts.

### 4.9 Dataset Shard Migration, Caching, and Low-Latency Access

In embodiments, the system stores large historical datasets (e.g., asset-utilization transactions, outcome datasets, demographic features, rulepack histories) as shards across distributed memory devices and/or data centers. To sustain low-latency inference and optimization, the system migrates dataset shards based on predicted access patterns, data-locality heuristics, and compute placement. For example, the system may compute a predicted cost of remote access (latency, bandwidth, egress cost) and a predicted benefit of migration (cache hit improvement, reduced tail latency), and migrate shards when a threshold heuristic is met. Migration may include prefetching, replication, and eviction policies, and may emit ShardMigrationReceipts binding shard_id, source_device_id, target device_id, timestamps, and access-metric justification.

### 4.10 Secure Inference, Environment Attestation, and Model Provenance

In embodiments, model inference and receipt generation occur in a trusted execution environment (TEE) or secure enclave, and the system produces remote attestation evidence that the expected code and model version ran in a trusted state. Attestation evidence (e.g., enclave measurement hashes, signing key identifiers, and attestation reports) may be bound into receipts so an auditor can verify that the kernel decisions were generated by an authorized model under an authorized environment. In some embodiments, the system uses hardware-backed keys (e.g., a TPM or HSM) to sign receipts, uses per-tenant key separation, and rotates keys under governance pack controls. Model provenance may be tracked using model identifiers, hashes, and version metadata stored in a ModelRegistry.

### 5. Ownership Entity Selection and Ownership-from-Usage Detachment

### 5.1 Ownership Entity Database

In embodiments, the system maintains an ownership-entity database that stores records describing candidate specialized ownership entities. A specialized ownership entity may be characterized by one or more attributes, including: entity_type (e.g., LLC, trust, nonprofit, foundation, cooperative, benefit corporation, captive, SPV, or other), jurisdiction, tax treatment attributes, governance rules, debt capacity, risk appetite, eligibility for certain incentives, licensing or regulatory status, ability to enter into and enforce usage-rights instruments, to participate in clearing groups for multilateral netting, and to settle obligations across supported payment rails

Entity records may include: entity_id, jurisdiction, permissible asset classes, permissible usage-rights instruments, fee schedule, benefit-sharing parameters, collateral requirements, and historical performance. In some embodiments, entity records include one or more machine-readable governance constraints, such as allowable distributions, required reserve ratios, permitted counterparties, or minimum trust coefficients.

### 5.2 Objective Function for Expected Collective Economic Benefit

In embodiments, the system computes an objective function representing expected collective economic benefit. The objective function may be defined over one or more stakeholders, including the user, the selected entity, counterparties, and optionally a broader clearing group or community pool. The objective function may incorporate, without limitation: (i) expected after-tax return, (ii) costs avoided (fees, interest, penalties), (iii) utilization improvements, (iv) compliance risk reduction, (v) risk-adjusted cash flow timing, (vi) reduced transaction volume, and (vii) measured surplus created by transaction compression.

In one non-limiting implementation, the objective function is evaluated over each candidate ownership entity e and candidate execution plan plan (including proposed settlement rails and compression actions) and computes J(e,plan)=Σ_k w_k·m_k(e,plan)−Σ_j λ_j·penalty_j(e,plan). Metrics m_k may include, without limitation: projected gross-to-net reduction; projected intermediary fee displacement; projected latency reduction (e.g., fewer network hops and fewer external API calls); projected reduction in exception-handling rate; projected reduction in storage and transmission cost via receipt-spine compression; projected compliance satisfaction (e.g., predicate pass rates under applicable rulepacks); and projected security posture improvement (e.g., reduced exposure surface via internalization and cryptographic attestation). Penalty terms may encode hard/soft constraint violations (e.g., prohibited transfers, segregation requirements, minimum net-pay floors, privacy disclosure budgets, or consent requirements). In embodiments, the system binds the evaluated metrics, weights, and selected maximizer into an EntitySelectionReceipt or OwnershipAllocationReceipt so that the selection can be independently verified and deterministically replayed.

In some embodiments, the objective function additionally (or alternatively) includes explicit computer-function and infrastructure terms, so that the selected ownership configuration and settlement plan are optimized not only for economic outcomes but also for measurable technical effects. For example, the objective function may include a term that minimizes a number of settlement messages, a number of settlement legs, or a message payload size relative to a baseline gross-obligation plan; a term that minimizes storage and compute required for audit and reconciliation by producing canonical receipt bundles and deterministic replay artifacts; a term that minimizes cross-domain data movement under data-residency constraints; and/or a term that minimizes an estimated attack surface by reducing intermediary hop count and external API exposure. In embodiments, the selected objective weights and computed technical-effect metrics are bound into receipts (e.g., EntitySelectionReceipts and Proof-of-Netting receipts) to support later verification and replay.

In some embodiments, the objective function is constrained by rulepacks and policies that prevent impermissible transfers or circumvention of participant protections. For example, the system may treat certain entitlements as non-transferable in ownership but still model them as part of an optimization state, thereby allowing the system to optimize around them without attempting to violate applicable restrictions.

### 5.3 Ownership-from-Usage Detachment and Usage-Preservation Instruments

A core technical aspect of embodiments is detaching ownership from usage. The system can transfer legal title or other ownership rights to a selected entity while preserving, for one or more users, continuity of usage through enforceable usage-rights instruments. Examples include: leases, rentals, long-term usage agreements, licenses, service-level agreements, access tokens, time-slice permissions, or other structures that grant possession or access without requiring the user to hold title.

In embodiments, encoding the transaction parameters includes generating, in memory, (i) a conveyance record designating the selected entity as owner of the asset and (ii) a usage-agreement record granting the user possession or access. The system may then execute and store the executed records in a database of assets, ownership entities, and users. The system may further compute and store a benefit-sharing parameter that is redistributed to the user (for example: a portion of tax savings, discount capture, fees avoided, or surplus created by netting).

### 5.4 Continuity of Access and Re-Titling Over Lifecycle

In embodiments, the system repeats the evaluate-and-optimize process over time to detect when re-titling would deliver an improvement above a threshold. The system can invoke another title-transfer routine that assigns the asset to a newly selected entity without interrupting user access. Continuity may be ensured by overlapping usage-rights grants, escrowed transition steps, atomic settlement groups, or other transaction controls. The system dispatches an electronic alert to confirm continuity of usage following ownership reassignment.

### 5.7 Granular Rights Decomposition and Hybrid Asset Classes

In embodiments, an asset is decomposed into granular rights and obligations, including without limitation: legal title, beneficial interest, usage rights, cash-flow rights, risk/insurance obligations, tax attributes, governance/voting rights, and transfer restrictions. The most-efficient-use vector may include a recommended decomposition and recomposition of such rights, enabling the system to classify a resource as a hybrid asset class that is simultaneously a financial asset, a service entitlement, a tax-advantaged right, and a usage capacity. The ownership-inefficiency differential can reflect misalignment between how rights are currently packaged and how they should be packaged under current constraints.

In some embodiments, parcelization and wrapper rebinding are implemented by an Asset Wrapper Engine that treats ownership wrappers (e.g., personal, business, nonprofit, cooperative, trust, captive, foundation-owned operating company, governmental, or hybrid) as first-class machine objects rather than as informal mental models or purely economic labels. By encoding wrapper feasibility tests, wrapper transitions, and legal/tax constraints as machine-checkable predicates in the policy lattice, the platform improves the functioning of the computing environment by compressing the search space of feasible classifications (e.g., pruning wrappers that fail threshold tests), reducing misclassification and rework, and enabling deterministic replay of complex reorganizations.

In one non-limiting implementation, an AssetParcel data structure includes fields such as {parcel_id, asset_id, right_type, quantity, time_window, constraint refs[ ], origin receipt ref, current_wrapper_ref, current_entity_id, valuation_vector, risk_vector}. A parcel may represent, for example, (i) a title interest, (ii) a usage-only token or leasehold, (iii) a cash-flow right, (iv) an insurance obligation, (v) a tax attribute (e.g., basis, holding period, credit eligibility), or (vi) a time-windowed regulatory opportunity (e.g., a penalty window or expiring credit). Parcels may be nested or linked, and each parcel may be referenced by subsequent receipts and settlement plans.

In embodiments, the platform emits an AssetParcelReceipt when parcels are created or modified, a WrapperEvaluationReceipt when candidate wrappers are evaluated (including which wrappers were pruned and why), and a WrapperBindingReceipt when a selected wrapper and ownership entity are bound to a parcel and committed to the receipt ledger. In embodiments, these receipts include pre-state and post-state hashes so that the wrapper changes are replayable and auditable, and include policy bindings (rulepack_id/rulepack_hash) used to authorize the transition.

### 5.8 Non-Transferable or Transfer-Restricted Entitlements

Some assets have legal or contractual restrictions that limit transfer of title (e.g., certain plan entitlements, retirement accounts, or restricted securities). In embodiments, the kernel treats such restrictions as hard constraints and, where direct title transfer is prohibited, encodes an economically equivalent structure that preserves compliance. For example, the system may encode (i) a usage-rights instrument that grants a right to participate or to receive proceeds, (ii) an assignment of cash flows or discount value, (iii) an internalized advance secured by anticipated proceeds, or (iv) a synthetic exposure (e.g., a contract that references a future settlement value) that allocates economic benefit without transferring prohibited legal title. Receipt bundles bind the chosen structure and the restriction predicate.

### 5.9 Usage-Rights Enforcement and Continuity Mechanisms

In embodiments, continuity of usage is enforced by one or more technical primitives, including: access-control lists bound to UOTs; API-gated entitlement checks (e.g., “allow access if UsageContinuityReceipt is valid and not revoked”); device- or vehicle-level access tokens; scheduling locks for time windows; and revocation pointers to status lists. Where an asset is tangible (e.g., a vehicle), the usage-rights instrument may be enforced via telematics or digital keys; where an asset is intangible (e.g., a benefit entitlement), the usage-rights instrument may be enforced via plan administration APIs and settlement gating.

### 5.10 Entity Template Library and Wrapper Selection

In embodiments, the ownership-entity database includes a template library of entity types, each with parameters, constraints, and governance controls. Example templates include, without limitation: single-purpose entities, cooperatives, nonprofit entities, charitable trusts, employee ownership structures, foundation-owned operating company wrappers, captive insurance wrappers, and other specialized entities permitted under applicable law. The objective function can evaluate candidate templates using measurable inputs (tax attributes, liability isolation, financing terms, governance constraints, fee structures, compliance burden, and surplus routing goals). Selection receipts bind the template identifier, parameter values, and ranking metrics.

In embodiments, wrapper selection is performed as a constrained search over template instances. A wrapper template may define required parameters (e.g., jurisdiction, governance rules, beneficiary class, reserve policy, disclosure posture, or tax elections) and a set of feasibility predicates compiled into the policy lattice. The system instantiates candidate wrappers from templates, evaluates each candidate wrapper by executing the compiled predicates and computing objective-function components, and emits a WrapperEvaluationReceipt that records the candidate set, pruning reasons, and computed scores.

When a candidate wrapper is selected, the system generates and commits wrapper-binding artifacts (e.g., organizational documents, elections, and registry filings where applicable) and emits a WrapperBindingReceipt that binds {parcel_id(s), wrapper_template_id, parameter_values, entity_id, rulepack_id/rulepack_hash, pre_state_root, post_state_root}. In embodiments, subsequent lifecycle events can trigger wrapper rebinding (e.g., conversion from a personal wrapper to a cooperative wrapper or a philanthropic wrapper) and are recorded in WrapperRebindingReceipts linked to the original binding chain.

Non-limiting examples of wrapper templates include: (i) a cooperative or mutual entity template configured to pool risk and surplus; (ii) a nonprofit or foundation-owned operating company template configured to route profits or surplus to charitable beneficiaries while maintaining for-profit operational control; (iii) a trust or special-purpose vehicle template configured to hold title while granting usage rights; and (iv) a captive or segregated-cell template configured to internalize insurance/underwriting functions. These examples are provided to illustrate reuse of the same kernel with domain-specific constraints pushed into template parameters and rulepacks.

### 6. Receipt-Native Event Ledger, Auditability, and Security

### 6.1 Receipt-Native Execution and Typed Receipts

In embodiments, execution is receipt-native: the system emits structured, typed receipts for the major state transitions of the kernel. Typed receipts are machine-parseable objects whose schema is stable across domains, enabling a repeatable and scalable compliance and audit posture as the kernel is applied across verticals.

Examples of receipt types include, without limitation:
OwnershipAllocationReceipt: binds the asset_id, user_id, observed/declared usage state, most-efficient-use vector, and the computed ownership-inefficiency differential;
EntitySelectionReceipt: binds the candidate entity list, ranking metrics, objective-function values, and the selected entity_id;
ConveyanceReceipt: binds the executed conveyance record and any title-transfer identifiers;
UsageContinuityReceipt: binds the executed usage-rights instrument and its continuity guarantees;
Proof-of-Netting (PoN): binds a settlement cycle's gross obligation vectors, offsets applied, exclusions, correlation identifiers, and the resulting net settlement vector;
Proof-of-Benefit (PoB): binds benefit-related actions (e.g., plan elections, purchases, matches, allocations) and references the originating PoN and period_id;
Proof-of-Classification (PoC): binds a work unit or classification decision, including the rulepack identifier and hash used, evidence inputs, and a rationale;
SettlementReceipt: binds payment instructions and settlement results, including cross-rail transaction identifiers.
CompressionOpportunityReceipt/CompressionProposalReceipt: binds a proposed compression or disintermediation action, baseline gross flows, predicted savings, and feasibility proofs.
CompressionExecutionReceipt/Proof-of-Compression: binds an executed compression action, before/after state roots, removed legs, and settlement identifiers.
TransitionReceipt (SunsetRecord) and TransitionProposalReceipt: bind intermediary internalization state transitions and routing changes with metric snapshots (e.g., IIndex, leakage, risk).
AssetParcelReceipt, WrapperEvaluationReceipt, WrapperBindingReceipt (and WrapperRebindingReceipt): bind parcelization and wrapper transitions with rulepack proofs and deterministic state roots.
PoolActivationReceipt/PoolCancellationReceipt: bind activation and unwind of pooled capital, risk, or entitlement containers, including segregation constraints and reserve proofs.
ExactlyOnceReceipt: binds an idempotent outcome of a state transition (e.g., EXECUTE vs DEDUP) together with the idempotency key and outcome digest.
ManagementDecisionReceipt: binds governance decisions, threshold changes, and policy-module configuration changes that affect execution behavior.

In embodiments, each receipt includes: a receipt_id; a schema_id (or type identifier); a timestamp and period_id; references to input record digests; a policy binding (rulepack_id and rulepack_hash, governance_pack_id and hash, or similar); and a signature or message authentication code.

In some embodiments, a timestamp token is included in a receipt bundle to prove existence of the receipt bundle at or before a time. For example, the timestamp token may comprise an RFC 3161-compliant time-stamp token issued by a trusted time-stamping authority, a ledger anchoring transaction identifier, or another verifiable time-binding artifact. Timestamp tokens can be used to support audit, dispute resolution, and deterministic replay across distributed participants.

### 6.2 Append-Only Event Ledger and Cryptographic Linking

In embodiments, receipts are written to an append-only event ledger. The ledger may be implemented using a log-structured storage system, a replicated event store, or a distributed ledger. In some embodiments, receipt digests are hash-linked to form a tamper-evident chain. Periodic checkpoints may be computed by building a Merkle tree over a batch of receipts and storing the Merkle root as a checkpoint digest. Checkpoint digests may be published, timestamped, or otherwise anchored to enable third-party verification.

The append-only ledger supports deterministic replay: by replaying receipts (or replaying events that generated receipts), a verifier can reconstruct past states of asset ownership, usage rights, objective-function inputs, and settlement outcomes.

### 6.3 Selective Disclosure, Privacy, and Redaction Controls

In embodiments, receipts are designed to be audit-grade while preserving privacy. For example, a receipt may store hashes of sensitive inputs, store encrypted payloads referenced by immutable headers, or store predicate proofs that demonstrate compliance without revealing raw values.

In embodiments that support controlled redaction, the system may store an immutable header containing a hash commitment to a payload reference and, upon authorized redaction, update the payload reference and recompute a chameleon hash under quorum control while emitting a redaction proof. The redaction proof can indicate what was redacted, by whom, when, and under which policy authority, without revealing the redacted content.

### 6.4 Security Controls and Trusted Execution

In embodiments, the system enforces confidentiality and integrity using encryption-in-transit, encryption-at-rest, key rotation, access control, and hardware-rooted trust. The AI inference and receipt generation processes may execute inside a trusted execution environment (TEE) or secure enclave, and may provide remote attestation evidence that a specific software and model version ran in a trusted state.

### 6.5 Correlation Identifiers and Interoperability

In embodiments, settlement legs and receipts are deterministically linked using settlement identifiers and correlation identifiers. Payment instructions may populate end-to-end identifiers (for example, ISO 20022 EndToEndId) and, where applicable, unique end-to-end transaction references (UETR) for cross-border tracking. These identifiers are preserved unchanged through intermediary chains and are bound in PoN and SettlementReceipts to enable end-to-end traceability.

### 6.6 Example Receipt Schemas and Canonical Fields

In embodiments, receipts are represented in a typed schema (e.g., JSON, CBOR, ASN.1, protocol buffers, or other schema) and include canonical fields to support verification and deterministic replay. Example canonical fields include: receipt_type; receipt_id; settlement_id; period_id; issuer_id; subject_id(s); correlation identifier(s); input_digests (hashes of referenced data objects); output_digests; policy_reference(s) (e.g., rulepack_id and hash); timestamp and timestamp-token fields; and signature and/or attestation evidence. In embodiments, a Proof-of-Netting (PoN) receipt includes gross obligation vectors, offsets applied, exclusions, net settlement vector, and identifiers for each leg; a Proof-of-Classification (PoC) receipt includes work_id, classification outcome, rulepack_id and hash, evidence digests, and rationale artifact digest; and a Proof-of-Benefit (PoB) receipt includes benefit actions, plan or program identifiers, and references to PoN receipts and settlement manifests.

In one representative schema, each receipt header includes: {receipt_type, receipt_id, ts, issuer_id, subject_id(s), rulepack_id, rulepack_hash, pre_state_root, post_state_root, input_digests[ ], output_digest, correlation_ids[ ], witness_refs[ ], sig[ ]}. The output_digest may be a hash of an executed payload or artifact (e.g., a conveyance record, settlement instruction bundle, or wrapper-binding packet) stored separately under controlled disclosure.

TransitionReceipt (non-limiting fields): {receipt_type=“TransitionReceipt”, function_id, prior_state, new_state, iindex_snapshot, leakage_snapshot, risk_snapshot, compliance_cost_snapshot, routing_action, affected_flow_ids[ ], rollback_criteria, ts, rulepack_id, pre_state_root, post_state_root, sig[ ]}.

CompressionOpportunityReceipt (non-limiting fields): {receipt_type=“CompressionOpportunityReceipt”, baseline_flow_ref, baseline_message_count, candidate_plan_ref, predicted_message_count_reduction, predicted_fee_displacement, predicted_latency_reduction, feasibility_proof_refs[ ], ts, rulepack_id, pre_state_root, post_state_root, sig[ ]}.

CompressionExecutionReceipt/Proof-of-Compression (non-limiting fields): {receipt_type=“CompressionExecutionReceipt”, baseline_flow_ref, included_obligation_ids[ ], applied_offsets[ ], removed_legs[ ], net_settlement_vector, settlement_receipt_refs[ ], exceptions[ ], ts, rulepack_id, pre_state_root, post_state_root, sig[ ]}.

WrapperBindingReceipt (non-limiting fields): {receipt_type=“WrapperBindingReceipt”, parcel_id(s)[ ], wrapper_template_id, parameter_values_hash, entity_id, filing_or_registry_refs[ ], constraint_proof_refs[ ], ts, rulepack_id, pre_state_root, post_state_root, sig[ ]}.

PoolActivationReceipt (non-limiting fields): {receipt_type=“PoolActivationReceipt”, pool_id, pool_type, activation_threshold_type, activation_threshold_value, observed_metric, reserve_proof_ref, participant_set_hash, segregation_constraints_ref, ts, rulepack_id, pre_state_root, post_state_root, sig[ ]}.

### 6.7 Hash Chaining, Merkle Checkpointing, and Deterministic Replay

In embodiments, the append-only event ledger stores receipts as hash-linked entries. For example, each entry may include a hash of the previous entry, forming a chain, and periodic checkpoints may compute a Merkle root over a batch of receipts. The Merkle root may be signed and stored as a LedgerCheckpointReceipt, enabling later proof that a given receipt existed at or before the checkpoint time. Deterministic replay is supported by storing sufficient inputs (or hashes and references to inputs), policy references, and execution artifacts so that a verifier can re-run the kernel and confirm that outputs match stored receipts.

In embodiments, storage and transmission are further optimized using receipt compaction and compression. For example, the system may store only hashes for large evidence artifacts, store pointers to encrypted blobs, delta-encode repeated fields across receipts, and compress receipt bundles using dictionary compression. Such compression reduces storage footprint and network bandwidth and can be measured as surplus attributable to the platform.

### 6.7.1 Receipt-Spine Compression and Merkle-DAG De-Duplication

In some embodiments, the platform implements receipt-spine compression to reduce redundant storage and transmission of repeated proof artifacts while preserving stateless verification. The receipt ledger and its supporting evidence artifacts are treated as a content-addressed directed acyclic graph (e.g., a Merkle-DAG) in which receipts reference shared sub-objects (e.g., policy proofs, timestamp certificates, credential manifests, Merkle inclusion proofs, and zero-knowledge proof blobs) by cryptographic hash rather than embedding duplicated payloads.

In one non-limiting implementation, the audit subsystem maintains a content store keyed by hash. When a new receipt is about to be committed, the subsystem extracts any large witness objects, computes hashes under a canonical serialization, and stores only missing objects. The committed receipt includes witnessRefs[ ] containing hashes (pointers) to those objects. A global spine root (e.g., a Merkle root over receipt headers and referenced objects) may be checkpointed periodically so that an auditor can perform a one-shot integrity check.

Receipt-spine compression yields technical effects including reduced storage growth (often sub-linear when many receipts share common proofs), reduced bandwidth for audit distribution, and faster verification because shared objects are fetched and verified once and then reused across many receipts. Importantly, compression does not change the logical verification outcome: given the same starting state and the same sequence of receipts and referenced objects, deterministic replay recomputes the same state roots and checkpoint hashes.

In some embodiments, receipt-spine compression is combined with materiality-aware retention and controlled redaction. For example, older receipts may retain only hashes of sensitive payloads while preserving proofs of effect, and redaction events are themselves recorded via RedactionReceipts that preserve chain integrity. In some embodiments, cryptographic suite identifiers are recorded so that older receipts remain verifiable under their original algorithms while newer receipts can migrate to updated suites.

### 6.8 Privacy-Preserving Audit and Controlled Disclosure

In embodiments, receipts are constructed to enable audit without unnecessary disclosure. For example, eligibility checks and threshold checks may be represented as boolean predicate proofs rather than raw wage, premium, or medical values. The system may use selective disclosure proofs and/or zero-knowledge proofs to demonstrate satisfaction of policy constraints. Reveal-after-commit policies may be enforced by the opaque-to-transparent adapter, and RevealReceipts may record what was revealed and under which disclosure budget. Where permitted, redaction may be implemented with redactable ledger entries, chameleon hashes, and quorum approval, with RedactionProof receipts indicating the authorization basis.

### 6.9 Key Management, Access Control, and Audit Separation

In embodiments, cryptographic keys for signing receipts, verifying credentials, and encrypting data are managed by a key management system (KMS) and/or hardware security modules (HSMs). Keys may be rotated, access policies enforced, and separation-of-duty controls applied such that no single operator can unilaterally forge or redact receipts. In embodiments, different key domains are used for (i) receipt signing, (ii) payment instruction signing, and (iii) credential issuance, and key identifiers are recorded in the corresponding receipts to support audit.

### 7. Multilateral Netting, Transaction Compression, and Atomic Settlement

### 7.1 Clearing Group and Obligation Ledger

In embodiments, one or more participants form a consented clearing group. A participant may be an individual, household member, employer, intercompany affiliate, plan administrator, benefits provider, insurer, lender, custodian, nonprofit entity, governmental payee, or other party to obligations. In embodiments, each participant is identified by an identifier (e.g., account_id, DID, or other).

In embodiments, obligations are recorded in an ObligationLedger as gross obligation entries. Each gross obligation entry may include: debtor_id, creditor_id, amount, currency, due_date, obligation_type, period_id, settlement_id, and one or more policy tags (e.g., “tax_withholding”, “premium”, “retirement_contribution”, “advance_repayment”, “wage_payment”, “benefit_match”, “donation”, etc.). The obligation entries may be created based on the executed conveyance and usage-rights instruments, benefit elections, payroll calculations, and other kernel outputs.

### 7.2 Netting Eligibility and Setoff Constraints

Not all obligations are nettable. In embodiments, netting is constrained by legal mutuality rules, timing requirements, consent predicates, segregation rules, and policy constraints. For example, certain withholdings or trust funds may be segregated and may not be offset against unrelated obligations. The system enforces netting eligibility by evaluating netting constraints as predicates over the obligation entries. The netting constraints may be included in the relevant rulepacks, governance packs, or participant agreements.

### 7.3 Network-Flow Optimization for Multilateral Netting

In embodiments, the netting engine computes multilateral netting by solving a network-flow optimization that minimizes gross settlement volume subject to the constraints described above. In one example, the engine constructs a directed graph in which nodes correspond to participants and directed edges correspond to obligations. The engine seeks a feasible set of offsets that reduces the sum of absolute transfers while preserving net positions. In embodiments, the constraints include conservation-of-value constraints per clearing-group participant and setoff-right constraints encoded in a setoff policy matrix or equivalent rulepack representation; excluded obligations may be marked in an exclusion mask and optionally annotated with reason codes.

In some embodiments, the optimization includes additional terms (for example: minimizing settlement risk, minimizing number of rails used, minimizing expected fees, maximizing use of low-cost rails, or preserving priority tiers such as hierarchy-of-needs allocations). The output of the optimization is a net settlement vector specifying, for each participant, a net payable or net receivable amount for the settlement cycle, and a set of offset records describing which gross obligations were offset.

In one non-limiting implementation, gross obligations are represented as a matrix G where G[i,j] is the gross amount owed from participant i to participant j for a given settlement_id. The netting engine may compute each participant's net position as net[i]=Σ_j (G[j,i]−G[i,j]) subject to policy constraints that restrict which entries may be offset (e.g., trust funds, segregated withholdings, non-nettable categories). Where additional constraints apply (e.g., maximum exposure caps, collateralization, rail capacities), the engine may formulate a min-cost flow or linear program to minimize an objective such as total settlement volume, total rail fees, or total number of settlement legs while satisfying feasibility constraints. The solution yields a set of settlement instructions whose aggregate effect is equivalent to the gross obligations but with reduced transaction count.

### Illustrative Multilateral Netting Pseudocode (Non-Limiting):

inputs: obligations O={(i,j,amount,tag)}, eligibility predicates E(tag), costs C(rail) build directed graph with nodes=participants; add edge i→j with capacity=amount if E(tag)=true solve min-cost flow/LP to minimize (Σ legs fee+α·Σ legs count) subject to flow conservation and caps
output settlement legs L={(src,dst,net_amount,rail)}; compute net vector; emit PoN receipt binding O and L

### 7.4 Proof-of-Netting Receipts and Settlement Manifests

In embodiments, the engine generates a Proof-of-Netting (PoN) receipt that binds: the settlement_id and period_id; the gross obligation entries included; the offsets applied; any excluded obligations and reasons for exclusion; and the resulting net settlement vector. The PoN may further bind correlation identifiers (e.g., payment message EndToEndId fields) that will be preserved through settlement. In some embodiments, the PoN receipt further binds an exclusion mask aligned to the gross obligation vector and, for each excluded obligation, a reason code identifying a policy node of the setoff policy matrix (or other rulepack predicate) that caused the exclusion.

In embodiments, the engine generates a settlement manifest that enumerates the payment instructions generated from the net settlement vector, including the target rails for each instruction.

### 7.5 Atomic Settlement Groups Across Heterogeneous Rails

In embodiments, the system executes payment instructions as an atomic settlement group across heterogeneous payment rails, such that either all legs of a grouped settlement succeed or the group is rolled back or compensated. Rails may include, without limitation: ACH, RTP, wire, card rails, internal ledger transfers, and programmable/token rails. Atomicity may be implemented using a two-phase commit protocol, conditional transfers, escrow-and-release patterns, or equivalent mechanisms.

In embodiments, successful settlement results in a SettlementReceipt that binds: the PoN receipt_id; the settlement manifest; the rail transaction identifiers; and any exceptions or retries.

In some embodiments, the atomic settlement group is implemented using coordinated commit/compensate logic. For example, the system may generate an idempotency key and group_id for the settlement group, issue “prepare” instructions to one or more rails that support reservation/authorization, and upon successful preparation, issue “commit” instructions. Where a rail does not natively support prepare/commit semantics, the system may use an escrow, conditional release, reversible payment window, or compensating transaction strategy. Each leg may be bound to the group id and correlation identifier, and the SettlementReceipt may record, for each leg, a rail transaction identifier, status, retry count, and any compensation actions. By preserving end-to-end identifiers across rails, the system enables cross-rail reconciliation and reduces error-prone intermediary reconciliation steps.

### 7.6 Transaction Compression and Disintermediation

The netting and atomic settlement mechanisms provide technical transaction compression: multiple gross obligations are replaced by fewer net transfers, reducing message count, reducing intermediary hops, and reducing opportunities for failure or fraud. In embodiments, the system further internalizes intermediary steps (for example: advances used to fund benefit participation, fee-charging middlemen, or multi-hop transfers) by moving those steps into the kernel's netting and settlement loops. By reducing the number of transfers and the number of parties required to coordinate settlement, the system can improve security, reduce retry storms, reduce reconciliation load, and reduce costs.

### 7.6.1 Intermediary Internalization Controller, Interdependence Metrics, and Proof-Carrying Transitions

In some embodiments, transaction compression and disintermediation are further supported by an intermediary internalization controller that treats external intermediary functions as controllable policy modules. The controller reads a Network Interdependence Graph representing participants and value/rights flows, maintains (per intermediary function) an internalization state selected from {External, Hybrid, Internalized, Retired}, and drives state transitions and routing changes while emitting TransitionReceipts appended to the receipt ledger.

In embodiments, the controller computes an interdependence index (IIndex) for the network and/or for specific nodes or functions as a weighted sum of normalized metrics. In one non-limiting example,

IIndex(t)=w1·R_reuse(t)+w2·D_net(t)+w3·P_cred(t)+w4·S_surplus(t)−w5·R_frag(t), where R_reuse reflects cross-participant reuse of parcels (e.g., task parcels, capacity parcels, or shared modules), D_net reflects multilateral netting density (e.g., ratio of obligations settled through netting vs gross transfers), P_cred reflects portability utilization of credentials/clearances, S_surplus reflects a surplus-to-fee ratio (e.g., fraction of measured surplus retained by participants vs captured by fee-taking intermediaries), and R_frag reflects fragility or concentration (e.g., reliance on a single intermediary or single point of failure). Weights w1 . . . w5 may be policy-configurable and versioned in rulepacks.

In embodiments, for an intermediary function F with an externalization profile Profile(F) (including leakage L(F), risk Risk(F), and compliance overhead Cost_comp(F)), the controller computes an internalization score for a candidate host node N. In a non-limiting example, Score(F,N)=α·L(F)+β·ΔIIndex(F,N)−γ·ΔRisk(F,N)−δ·ΔCost_comp(F,N), where Δ terms estimate the change if flows currently routed through F are rerouted to an employer-native, consortium, cooperative, or network-native module. When Score(F,N) meets or exceeds a threshold T(F_type,J) for a function type and jurisdiction, the controller emits a TransitionProposalReceipt and (when authorized) a TransitionReceipt that binds the decision inputs, metrics, policy references, and the concrete routing/settlement actions scheduled.

In some embodiments, internalization is treated as a controlled Markov decision process over the internalization state machine, with rewards parameterized by measured gross-to-net reductions, fee displacement, latency reductions, error rates, and surplus routing outcomes. The controller may automatically revert a module from Internalized to Hybrid or External when key performance indicators degrade (e.g., default rates spike or compliance risk increases), while preserving an auditable receipt trail of the transition and rollback.

By representing internalization decisions with explicit indices, thresholds, and proof-carrying receipts, embodiments convert informal vendor-management and governance processes into deterministic, auditable control logic that reduces external API dependencies, reduces message hops, narrows attack surface, and enables phased disintermediation (e.g., third-party function→in-plan function→network-native cooperative function) without changing the core kernel structure.

### 7.7 Netting Mathematics, Graph Models, and Optimization Engines

In embodiments, gross obligations for a settlement cycle are represented as a directed graph G=(V,E) where vertices V are participants and edges E are gross obligation entries. Each edge e=(u→v) carries an amount a_e and tags indicating obligation type and constraints. A net settlement vector can be computed by summing outgoing and incoming obligations per participant: net(v)=Σ_in a_e−Σ_out a_e (subject to eligibility constraints). In embodiments, the system computes a netting plan that minimizes a cost function, such as total transferred notional, number of rails messages, or expected failure risk, subject to constraints (e.g., segregation constraints, caps, timing constraints). The optimization may be solved using network flow (e.g., min-cost flow), cycle-canceling, linear programming, or other methods and may emit a NettingPlanReceipt binding the algorithm id, objective value, and constraint set. The netting engine computes a net settlement vector (also referred to herein as a netting vector) and, in some embodiments, a reduced settlement graph that can be executed with fewer settlement legs than a baseline gross-obligation graph. In embodiments, the system computes one or more compression metrics such as transaction-count reduction, message-count reduction, and/or notional reduction by comparing the baseline gross representation to the netted representation (for example, comparing |E| to |E′| and/or gross notional to net notional), and binds such metrics, along with algorithm identifiers, objective values, and constraint-set identifiers, into a Proof-of-Netting (PoN) receipt for deterministic replay and audit.

In one non-limiting implementation, the system computes a baseline transaction count N_gross as a count of gross obligation entries (or edges) for the settlement cycle, computes a net transaction count N_net as a count of settlement legs required to execute the atomic settlement group after netting and exclusion constraints, and computes a compression ratio CR=(N_gross−N_net)/max(1, N_gross). The system may similarly compute a message-volume metric (e.g., bytes transferred) and a reconciliation-operations metric and include these values as fields in the PoN receipt and/or as inputs to the collective economic benefit objective function.

### 7.8 Predictive Netting and Reservation of Offsets

In embodiments, the system performs predictive netting by forecasting future obligations and opportunities for offset, enabling earlier reservation or pre-authorization of offsets. For example, internalized advances for benefit participation may be reserved against future payroll cycles, and anticipated tax withholdings may be scheduled to net against reimbursements or rebates where permitted. Predictive netting can reduce last-minute liquidity demands and can smooth settlement loads across calendar boundaries. Such reservations may emit OffsetReservationReceipts and may be enforced by governance packs.

### 7.9 Segregation Constraints and Protected Funds

In embodiments, certain obligation classes are treated as protected funds and are segregated from netting unless expressly permitted. For example, trust funds, escrowed amounts, or regulated withholding pools may require segregation. The system enforces segregation by tagging obligation entries with segregation classes and applying constraint predicates that exclude cross-class offsets. Proof-of-Netting receipts can record exclusions and their reasons, enabling audit of why particular gross legs were not offset.

### 8. Policy Lattice, Rulepacks, and Change-of-Law Adaptation

### 8.1 Policy Lattice and Constraint Compilation

In embodiments, the system represents rules and constraints as machine-executable artifacts rather than as ad hoc scripts or flat tables. A policy lattice may be used to encode precedence, supersession, and conflict resolution across overlapping policies. For example, a policy lattice can represent that a federal rule is overridden by a more stringent state rule for a specific jurisdiction, or that a plan-specific limitation is stricter than a baseline statutory threshold.

In some embodiments, the system implements a Jurisdictional Parameter Graph (JPG) in which nodes store versioned legal, regulatory, and plan parameters and edges represent precedence, hierarchy, temporal supersession, and cross-jurisdiction relationships. Each node may include an effective-date range, provenance metadata, and a signature or validation digest.

### 8.2 Rulepacks

In embodiments, rulepacks are derived from the policy lattice and/or the JPG. A rulepack is a versioned, jurisdiction-specific bundle of legal tests, factors, and thresholds used to classify labor or apply policy constraints. Each rulepack is identified by rulepack_id and version/hash. Receipts that depend on rule evaluation bind the rulepack_id and hash used, enabling deterministic reconstruction of the decision basis.

Rulepacks may encode, for example: labor classification tests, tax withholding rules, benefits eligibility rules, plan limits, safe harbors, segregation constraints for netting, and AI governance requirements for automated decision-making.

### 8.3 Change-of-Law Ingestion and Targeted Recomputation

In embodiments, the system ingests change-of-law updates from authoritative feeds or curated updates. The system compiles the updates into the policy lattice and/or JPG, emits a LawDeltaReceipt capturing the delta, and updates affected rulepacks. Rather than recomputing all decisions, the system can compute an affected-cohort predicate and trigger targeted recomputation for only the users, assets, or obligations impacted by the change.

For example, a change in a tax threshold, an ACA affordability percentage, or a plan limit can update a small subset of rule nodes and trigger recomputation for only those participants whose current configuration is near the threshold.

### 8.4 Labor Classification and W-2/1099 Orchestration Embodiments

In one class of embodiments, the asset being optimized includes a unit of work performed by a user. The system classifies each unit of work under a rulepack and emits a Proof-of-Classification (PoC) receipt. In some embodiments, work is parcelized into units and represented as a directed acyclic graph (DAG) of tasks, enabling fine-grained scheduling, classification, and settlement.

In embodiments, classification results can gate downstream actions such as whether wage withholding is applied, whether certain benefits are available, or whether a payment is routed as payroll versus contractor settlement. The system can maintain a classification timeline for a worker that enforces non-overlap and prevents inconsistent classifications for overlapping time intervals.

### 8.5 ACA Safe-Harbor Evaluation as Constraints

In embodiments involving employer-sponsored health coverage, the system evaluates affordability using one or more Affordable Care Act (ACA) safe harbor methods, including, for example, W-2 wages safe harbor, rate-of-pay safe harbor, and federal poverty line safe harbor. The system can choose a safe harbor method that yields compliance for a given worker or household, bind the method and input digests into receipts, and use the output as constraints in the optimization and actuation loops.

### 8.6 Jurisdictional Parameter Graph and Rule Precedence

In embodiments, policies, rules, and thresholds are represented in a jurisdictional parameter graph. Nodes may represent jurisdictions, employer plans, participant classes, asset classes, and effective-date windows. Edges may represent inheritance, overrides, supersession, and precedence relationships. For example, a federal rule node may be overridden by a state rule node for certain participants, and a plan-specific node may override defaults for a particular employer. Each rulepack can be compiled from a subgraph and assigned a rulepack_hash that binds the effective policy set for a given decision.

### 8.7 Change-of-Law Ingestion, Delta Compilation, and Receipts

In embodiments, changes in law, policy, or plan parameters are ingested as structured deltas. A change-of-law pipeline may include: receiving a change notice, parsing it into machine-readable deltas, validating deltas against syntactic and semantic constraints, and compiling updated rulepacks. The system may emit LawDeltaReceipts that bind the change source, effective date, affected nodes, and resulting rulepack hashes. By binding deltas into receipts, the system can demonstrate which decisions were made under which policy snapshot.

### 8.8 Targeted Recomputation and Cached Decision Invalidation

In embodiments, the system performs targeted recomputation when rules change. Rather than recomputing all decisions, the system identifies affected decision classes (e.g., particular jurisdictions, plan types, or obligation tags) and triggers recomputation for only those decisions or forecasts. Cached most-efficient-use vectors, entity rankings, or netting plans that depend on superseded rulepacks may be invalidated, and recomputation actions may emit RecomputeReceipts referencing the triggering LawDeltaReceipt.

### 8.9 Policy-Lattice Gating and Compliance Proofs

In embodiments, the policy lattice gates execution by evaluating whether a candidate action satisfies constraints. For example, a title-transfer routine may be gated by transfer restrictions, a netting offset may be gated by setoff mutuality and segregation constraints, and a plan election may be gated by eligibility and limit constraints. The system may generate ComplianceProofReceipts that bind the evaluated predicates, rulepack references, and outcomes of the gating checks, enabling later demonstration that execution complied with the applicable policy snapshot.

### 9. Vertical Embodiments and Product-Level Configurations

The kernel described above can be applied across many verticals. The following embodiments are examples of product-level configurations that share the same kernel, data objects, receipt grammar, and execution primitives. These embodiments are intended to support dependent-claim scope and to provide enablement for multiple industries while maintaining a single coherent invention.

### 9.1 Workplace Benefits Autopilot: ESPP and Retirement Participation

In one embodiment, the asset includes an employee stock purchase plan (ESPP) entitlement, a retirement plan entitlement (e.g., 401(k)), or related benefit rights. The system ingests plan parameters, eligibility, and limits (e.g., purchase limits, contribution limits, offering windows, discount rules), and predicts a most-efficient-use vector representing a configuration that captures available benefits (e.g., employer match, discounts, or tax advantages) subject to constraints.

In embodiments, the system can internalize advances used to fund “pay-to-play” benefits. For example, when a user lacks liquidity to fully fund a payroll deduction needed to capture an employer match or an ESPP discount, the system can generate an internalized advance obligation, include it in the ObligationLedger, and net its repayment against future payroll, benefit, or settlement legs. This avoids external intermediaries and reduces gross movement.

In embodiments, the system generates a Proof-of-Benefit receipt that binds plan configuration, purchase events, match capture events, and repayment or netting actions to the settlement cycle.

### 9.2 Payroll, Tax, and ACA Orchestration: W-2/1099 and Multi-Employer Coordination

In one embodiment, the asset includes work performed across one or more employers or engagements. The system parcelizes work into units and classifies each unit using rulepacks. The system can orchestrate compensation across W-2 and 1099 treatments, apply withholding and reporting rules, and evaluate ACA safe harbors as constraints on health coverage and affordability. The system can emit PoC and PoB receipts, and can generate actuation messages for payroll, benefits, and reporting systems.

In some embodiments, multiple employers participate in a clearing group and the system computes inter-employer settlements (for example, to allocate benefit costs or to reconcile shared labor) using multilateral netting.

In some embodiments, multi-employer coordination includes threshold-based pooling of capital, underwriting, and/or administrative functions. For example, multiple employers may participate in a pooled liquidity fund or cooperative underwriting pool that finances cashless participation (e.g., internalized ESPP/retirement advances or premium bridges) and is repaid via netted payroll or settlement cycles. The pool is represented as a PoolContainer with segregation constraints and reserve proofs, and is activated only when configured thresholds are met (e.g., minimum scale, reserve coverage, diversification), as recorded in a PoolActivationReceipt. This pooling supports phased disintermediation by allowing the network to transition from external intermediaries to employer-native and then network-native mechanisms under the intermediary internalization controller.

In embodiments involving recoupment, deductions, offsets, or repayment via payroll, the platform enforces wage-assignment and deduction compliance (e.g., permissible deduction categories, consent-artifact requirements, caps, and minimum net-pay floors). In a non-limiting example, a DeductionPolicy object includes fields such as {basis, authority, cap, consent_artifact_ref, priority, jurisdiction_label} and is bound to each deduction in the relevant receipts. If a deduction would violate a minimum wage or overtime floor, the platform schedules recovery across future periods and records the adjustment as a policy-gated receipt entry.

In some embodiments, the platform defines vendor onboarding prerequisites to compete in the network. For example, marketplace participants may be required to support verifiable credential exchange (e.g., KYC/KYB, licensing, insurance proofs), event-signed receipting, refund/chargeback service-level commitments, and programmatic proration. Noncompliant providers may be sandboxed or automatically sunset by the intermediary internalization controller, with enforcement actions recorded in receipts to maintain an auditable basis for exclusion and to preserve deterministic replay of network state.

### 9.3 Intercompany and Household Netting: Payment-Rail Compression

In one embodiment, the clearing group includes both a household participant and one or more intercompany participants. The system aggregates obligations across household and enterprise domains into a unified ObligationLedger keyed to a period_id and settlement_id, and computes multilateral netting to reduce gross settlement volume. In embodiments, this reduces the number of transfers, internalizes management or platform intermediaries, and yields a quantifiable surplus measured as gross-to-net reductions and fees avoided. Surplus can be recorded in SurplusReceipts and distributed using benefit-sharing parameters or governance rules.

### 9.4 Nonprofit, Cooperative, and Philanthropic Enterprise Ownership Wrappers

In one embodiment, the ranked candidate list of specialized entities includes nonprofit entities, cooperative entities, or philanthropic enterprise structures. For example, an asset may be titled to a nonprofit or foundation-owned entity while usage rights remain with a user, and benefit-sharing parameters can route measured surplus to community pools, philanthropic distributions, or stakeholder rebates. The same selection, conveyance, usage-preservation, netting, and receipt processes apply. Receipts can encode governance constraints and distributions.

### 9.5 Sale-Leaseback, Lifecycle Transfers, and Hybrid Asset Classes

In one embodiment, the system applies to tangible assets (e.g., real property, vehicles, equipment) and executes sale-leaseback style structures that detach ownership from usage. The system can continuously evaluate the asset over its useful life and re-title between entities as financing terms, risk, maintenance, or regulatory factors change, while preserving user access through usage-rights instruments. In embodiments, the system supports hybrid asset classes in which a single resource can be decomposed into granular rights (title, usage, cash flow, risk, and governance) and recomposed into optimized ownership and settlement structures.

### 9.6 Token Rails, Programmable Settlement, and Decentralized Finance Overlays

In one embodiment, the system executes settlement legs on programmable/token rails. Usage rights, benefit entitlements, or settlement obligations may be represented by tokens or tokenized claims. The system can still enforce rulepack constraints, generate receipts, and execute atomic settlement groups that combine traditional rails and token rails. In embodiments, selective disclosure and credential-based access controls reduce identity leakage while enabling interoperable settlement.

### 9.7 Insurance, Underwriting, and Risk Pooling Embodiments

In one embodiment, the asset includes insurance capacity, risk pool participation, or premium obligations. The system ingests policy parameters, coverage constraints, deductible and copay structures, and risk signals derived from receipts (e.g., prior settlement behavior, credentialed training, or usage patterns). The most-efficient-use vector may include an optimized coverage configuration and premium schedule. The system can internalize intermediary functions such as broker-mediated quoting by using the AI categorization engine to evaluate offers and constraints, and by producing cryptographically verifiable receipts evidencing how coverage decisions were made under an active rulepack and governance pack.

In embodiments, premium obligations, reimbursements, rebates, and claim payouts are recorded as obligation entries and netted within a settlement cycle subject to segregation constraints. For example, premium payments may be netted against rebates or reimbursements where permitted, reducing gross transfers and settlement friction. Proof-of-Netting receipts and Proof-of-Benefit receipts can bind underwriting decisions, coverage changes, and settlement outcomes to policy references and evidence receipts.

### 9.8 Mortgage, Housing, and Debt Optimization Embodiments

In one embodiment, the asset includes a housing-related right or obligation, including mortgage obligations, refinancing options, escrow accounts, or usage rights in a dwelling. The system ingests loan terms, rate schedules, points and origination costs, escrow schedules, property tax and insurance obligations, and user lifecycle constraints. The most-efficient-use vector may include a recommended refinancing or restructuring plan, including re-titling of ownership among specialized entities while preserving occupancy through a usage-rights instrument.

In embodiments, the system uses multilateral netting to compress related flows such as mortgage payments, escrow contributions, tax remittances, insurance premiums, refunds, and rebates, reducing intermediary hops and reconciliation. The policy lattice can encode constraints such as escrow segregation, servicing requirements, and jurisdictional rules, and receipts can bind the optimized plan and settlement execution to those constraints.

### 9.9 Calendar Dispersion and Busy-Season Compression Embodiments

In one embodiment, the kernel is applied to closing cycles, filing cycles, renewals, or other periodic deadlines (e.g., month-end close, year-end close, benefit renewals, or tax deposit schedules). The system uses the time fabric to normalize deadlines and may proactively redistribute workload and settlement actions across time windows to reduce congestion. For example, the system can pre-stage receipts, pre-authorize settlement legs, and forecast netting opportunities to avoid deadline-induced bottlenecks, while producing receipts evidencing the basis for timing decisions.

### 9.10 Subscription Lifestyle and Lifecycle Marketplace Embodiments

In one embodiment, the system supports end-to-end asset lifecycle transitions for subscription and sharing models (e.g., vehicles, housing, equipment, software, or services). Supply may be represented as VACs and demand as OTCs, and matching may occur under disclosure budgets. Ownership may be held by specialized entities while users obtain time-bounded usage rights, enabling a share-economy outcome without requiring a centralized middleman to manually coordinate each transaction. Multilateral netting and atomic settlement groups can compress recurring charges, refunds, deposits, and incentives into fewer settlement legs, and receipts enable audit of how matches and settlements were formed.

In embodiments, lifecycle marketplaces are implemented as subscription-based or entitlement-based pipelines in which users obtain time-bounded usage rights to assets (physical, digital, or service capacity) while legal title is held by a selected ownership entity. Entitlements may be represented as Usage-Only Tokens, quotas, or time slices and are managed by the orchestration engine under the policy lattice. Each allocation, transfer, depletion, renewal, or policy limit is recorded as a typed receipt.

Non-limiting receipt types for subscription and entitlement flows include: EntitlementTransferReceipts (tracking transfers between accounts or pools), UsageAllocationReceipts (tracking consumption of quota), UsageDepletionReceipts (tracking exhaustion of quota), SubscriptionPlanReceipts (tracking initial plan enrollment and allowances), SubscriptionRenewalReceipts (tracking periodic renewal and rolled-over units), TierEscalationReceipts (tracking upgrade/downgrade), and PolicyLimitReceipts (tracking blocked or adjusted actions due to policy or quota limits). These receipts bind before/after state roots so that subscription state can be deterministically replayed and audited.

In some embodiments, subscription and lifecycle marketplaces are coupled to the opaque-to-transparent adapter and reverse-auction ladder. For example, scarce service capacity (e.g., appointments, mentoring time, childcare slots, or work parcel bundles) may be represented as VACs and allocated via an AuctionBlock with a descending price schedule and controlled disclosure schedule. AuctionStepReceipts and related receipts provide an audit trail of how scheduling, fairness constraints, and participant eligibility affected match outcomes.

In embodiments, realized surplus from improved utilization (e.g., avoided idle capacity, avoided penalties, or reduced intermediary fees) is computed by a surplus engine and recorded in SurplusReceipts that are linked to the originating allocation or auction receipts. In some embodiments, the platform posts hybrid transaction entries that include both a consumption leg (the immediate exchange) and an investment leg (a pro-rata share of surplus units), enabling downstream distribution under policy (e.g., participant dividends, resilience reserves, or philanthropic routing).

### 10. AI Governance, Explainability, and Human Override Controls

In embodiments, the system includes an AI governance pipeline that gates model-influenced recommendations and actions. The governance pipeline can be implemented as an “AI exoskeleton” that sits between model services and authoritative state stores and actuation endpoints.

### 10.1 Governance Packs and Jurisdiction-Scoped Controls

In embodiments, the policy lattice supplies governance packs that specify jurisdiction-scoped requirements for automated decision making, including notice requirements, record retention, locality constraints, bias metric reporting, and escalation thresholds. The system binds governance pack identifiers and hashes into AI-related receipts.

### 10.2 Confidence Gating and Fallback Behavior

In embodiments, model outputs are gated by confidence thresholds. For example, conformal prediction or calibrated uncertainty estimation can be used to determine whether a model output is sufficiently reliable to be used for autonomous actuation. When confidence is below a threshold, the system can fall back to deterministic rules, reduce scope of actuation, or route the case to a human reviewer.

### 10.3 Explainability Artifacts and Decision Receipts

In embodiments, when a model influences an action, the system generates decision receipts that include: model_id and model_hash; input feature digests; confidence scores; explanation artifacts (e.g., feature attribution summaries, counterfactual summaries, or rule-based rationales); and a linkage to the downstream actuation or settlement receipts. These artifacts can be used for audit and to support compliance with automated-decision governance requirements.

### 10.4 Human-In-the-Loop Overrides

In embodiments, a human reviewer can approve, modify, or deny an AI recommendation. The system records a HumanOverrideReceipt that captures the human identity (or role credential), the decision, and a rationale. Human overrides can be used to refine subsequent model training, to update rulepacks, or to adjust trust coefficients for participants or data sources.

By implementing governed AI decision-making with receipts, the system enables AI to replace many manual intermediary functions (e.g., human brokers or decision-makers) while preserving accountability, auditability, and policy compliance.

### 10.6 Model Provenance, Model-Card Receipts, and Audit Artifacts

In embodiments, each model version used by the categorization engine is identified by a model_id and a model hash and is accompanied by metadata (e.g., training data window, calibration parameters, and intended use constraints). The system may generate a ModelCardReceipt binding the model_id, model hash, calibration artifacts, and governance approvals (e.g., a signature from an authorized governance key). Such receipts enable an auditor to verify which model produced a decision.

### 10.7 Confidence Gating, Conformal Thresholds, and Safe Fallback

In embodiments, the system computes a confidence measure for model outputs and gates actuation when confidence is below a threshold. For example, the system may compute conformal prediction intervals or other uncertainty bounds and require that a recommended action meet a coverage constraint before execution. When uncertainty is high, the system may (i) defer execution, (ii) request additional evidence, (iii) run alternative models, or (iv) fall back to deterministic rules under the policy lattice. Gating actions may emit AIGatingReceipts and record the fallback path chosen.

### 10.8 Explainability Artifacts and Rationale Receipts

In embodiments, the system generates explainability artifacts that are bound into receipts. For example, a decision may include a rationale artifact describing which features, constraints, and policy predicates most influenced the selection (e.g., SHAP-like contributions, rulepack predicate evaluations, or counterfactual tests). To protect privacy, the rationale artifact may be stored as a hashed commitment with controlled disclosure. The Proof-of-Classification, Proof-of-Benefit, or EntitySelectionReceipt can reference the rationale artifact hash and the disclosure budget governing its reveal.

### 10.9 Human Override, Dual Control, and Separation-of-Duty Receipts

In embodiments, certain actions require human approval or dual control, particularly where legal or safety constraints require oversight. A human override interface can present the recommended action and a rationale artifact, and may require two distinct authorized approvals to proceed. The system may issue HumanOverrideReceipts that record the identity (or credential) of approvers, the time of approval, the action approved, and any modifications, enabling audit and accountability.

### 11. Surplus Measurement, Benefit Sharing, and Regenerative Routing

In embodiments, the system measures surplus value created by optimization and transaction compression. Surplus value may be measured as, for example: fees avoided, interest avoided, gross-to-net reductions, retries avoided, reduced settlement failures, improved utilization, reduced storage footprint (via quantization and shard optimization), or reduced recomputation workload (via change-of-law deltas).

### 11.1 Surplus Receipts and Attribution

In embodiments, the system emits a SurplusReceipt that binds: the measurement basis (which receipts and periods were compared), the computed surplus value, and the attribution rule identifying which stakeholders contributed to the surplus and which stakeholders are eligible to receive distributions. The SurplusReceipt can reference PoN, PoB, PoC, and SettlementReceipts.

### 11.2 Benefit-Sharing Parameters and Distribution Rules

Benefit-sharing parameters can specify how measured surplus is redistributed. In some embodiments, distributions are routed to: user rebates, buffer funds, skill or upskilling pools, insurance reserves, community pools, or philanthropic distributions. Distribution rules may be stored as governance rulesets with identifiers and hashes, and distribution actions may be recorded as DistributionReceipts that reference the source SurplusReceipt.

### 11.3 Hierarchy-of-Needs Allocations

In some embodiments, a paycheck or settlement is allocated according to lexicographic tiers (e.g., physiological and safety obligations first, then financial-security obligations, then growth/discretionary allocations). The system can enforce that no lower-tier allocation occurs until higher-tier obligations are satisfied for the cycle, and can emit a Proof-of-Benefit receipt documenting the order-of-operations and the satisfaction of tier constraints.

### 11.4 Surplus Measurement Categories and Attribution

In embodiments, surplus is computed as a measured difference between a baseline and an optimized outcome attributable to the kernel. Surplus categories may include, without limitation: (i) gross-notional reduction from multilateral netting (e.g., Σ gross transfers−Σ net transfers); (ii) fees avoided by internalizing intermediary steps; (iii) interest saved or additional match/discount captured through optimized timing and participation; (iv) reduction in retries, chargebacks, or reconciliation labor; and (v) compute and storage savings achieved through quantization, sparsity, and receipt compression. Surplus may be attributed to contributors and participants using the receipt graph, for example by tracing which receipts and settlement actions produced a measurable gain.

### 11.5 Trust Coefficient Updates and Access-Tier Adjustment

In embodiments, the system computes a trust coefficient for participants, entities, or connectors based on evidence-rich receipts, settlement behavior, credential status, and dispute outcomes. The trust coefficient may adjust reserves, collateral requirements, disclosure budgets, or access tiers. For example, a participant with consistent completion evidence and low dispute rates may be granted lower reserve requirements or higher autonomy, while a participant with frequent reversals may require additional approvals or stricter netting constraints. Trust coefficient updates may emit TrustUpdateReceipts.

### 11.6 Hierarchy-of-Needs Allocation and Regenerative Routing

In embodiments, benefit sharing and allocation are constrained by a hierarchy-of-needs policy. For example, in a settlement cycle the system may allocate available funds first to essential obligations (e.g., tax withholding, insurance premiums, minimum debt service, essential housing/utilities), and only then to discretionary or growth allocations (e.g., savings, investments, philanthropic distributions). The system may enforce the hierarchy as rulepack predicates and emit Proof-of-Benefit receipts for each allocation step, each referencing the originating Proof-of-Netting and period identifier. In embodiments, surplus distributions are routed to regenerative pools (e.g., reserve funds, nonprofit missions, stakeholder rebates) according to a distribution_rules_id recorded in receipts.

### 12. Example End-to-End Processes

The following non-limiting examples illustrate end-to-end execution of the kernel and are intended to support enablement for a wide range of implementations.

### 12.1 Generic Ownership Allocation and Reallocation Loop

In one example, the system executes the following steps for a given user-asset pair:
(a) receive user and asset information, and ingest asset-utilization transaction data for the user-asset pair;
(b) compute or update model features and run the AI/ML categorization engine to output a most-efficient-use vector;
(c) compute an ownership inefficiency differential relative to observed/declared usage;
(d) if the differential exceeds a threshold, query the ownership-entity database, rank candidate specialized entities, compute an objective function over the ranked list, and select an entity;
(e) encode a conveyance record and a usage-rights record, execute the conveyance and usage rights grant, and store executed records;
(f) generate and store receipts (OwnershipAllocationReceipt, EntitySelectionReceipt, ConveyanceReceipt, UsageContinuityReceipt, and optionally PoN/PoB/PoC receipts);
(g) compute netting for related obligations and execute settlement as an atomic settlement group; and
(h) repeat upon new data, new usage, or rule changes, including re-titling without interrupting user access.

### 12.2 Example Pseudocode (Illustrative)

The following pseudocode is an illustrative example of the kernel and is non-limiting.

```
    inputs: user_id, asset_id, observed_usage, declared_usage, txn_history,
supplemental_data
features = featurize(txn_history, supplemental_data, observed_usage, declared_usage)
meu_vector, confidence = model_infer(features) # most-efficient-use vector
differential = inefficiency(meu_vector, current_state(asset_id))
if differential >= THRESHOLD and confidence >= CONF_THRESH:
  candidates = query_entities(asset_constraints(asset_id), rulepack_constraints(user_id,
asset_id))
  scored = score_entities(candidates, meu_vector, objective_fn)
  selected = argmax(scored)
  conveyance, usage_agreement = encode_transfer(asset_id, selected, user_id,
usage_rights_policy)
  execute(conveyance); execute(usage_agreement)
  receipts = emit_receipts(inputs_hash, model_hash, rulepack_hash, conveyance,
usage_agreement)
  obligations = derive_obligations(receipts, period_id)
  pon = netting_optimize(obligations, netting_constraints(rulepack_hash))
  settle_atomic(pon.settlement_manifest)
else:
  emit_receipt(‘NoActionReceipt’, reason=‘below threshold or low confidence’)
```

### 12.3 Example: ESPP Cashless Participation and Internalized Advance (Illustrative)

In one example, an employee is eligible for an ESPP offering with a discounted purchase. The system predicts that participating at the maximum permitted level would increase net benefit, but the employee lacks sufficient liquidity for payroll deductions. The system encodes an internalized advance obligation, nets the advance repayment against a later settlement cycle, executes the purchase and any sell-to-cover, and emits PoB and PoN receipts that bind the action to plan constraints and settlement identifiers.

In embodiments, the system verifies eligibility and plan constraints using one or more credentials and/or rulepacks (e.g., eligibility predicates, offering period dates, contribution limits, and any transfer restrictions), and represents the employee's participation capacity as a virtual asset container. The system may internalize an advance by selecting a specialized ownership entity (e.g., a plan-partner entity or financing wrapper) to temporarily fund an incremental contribution amount, encoding a repayment mechanism as a usage-rights and/or proceeds-rights instrument (e.g., automatic sale of a portion of acquired shares to repay the advance, subject to plan constraints). The system can net repayment obligations within a settlement cycle (e.g., against payroll deductions, reimbursements, or other eligible cash flows) using the multilateral netting engine, and emits receipts such as an EntitySelectionReceipt, ConveyanceReceipt, UsageContinuityReceipt, and Proof-of-Netting receipt binding the plan constraints and correlation identifiers for deterministic replay and compliance review.

12.4 Example: Task-Level W-2/1099 Classification with ACA Constraint (Illustrative)

In embodiments, each unit of work is represented as a taskoid record with canonical fields (e.g., work_id, jurisdiction, role, time window, location, and deliverable), and the system evaluates the record under a compiled jurisdiction-specific rulepack. The AI/ML engine may generate a classification score (e.g., employee vs. independent contractor) and an uncertainty value, and the policy lattice may impose confidence gates, dual-control requirements, or safe fallbacks when uncertainty exceeds a threshold. The system emits a Proof-of-Classification receipt that binds the rulepack_id/rulepack_hash, evidence inputs, model provenance (e.g., model_hash), and any explainability artifacts. Classification results can then gate downstream actuation such as withholding parameters, benefits eligibility, and ACA safe-harbor evaluation, with resulting compliance receipts bound to settlement identifiers for audit.

In one example, work is parcelized into units of work and classified under a jurisdiction-specific rulepack. The system evaluates alternative allocations of work across W-2 and 1099 treatments and chooses an allocation that maximizes household utility while satisfying classification defensibility thresholds and ACA affordability constraints. The system emits PoC receipts for each classification decision and PoB receipts for any coverage allocations.

In embodiments, the clearing group is constructed to include the household and associated enterprises as participants for the period, with gross obligations including wages, deductions, premiums, advances, reimbursements, refunds, and provider invoices. The system applies segregation constraints and setoff-right predicates (e.g., protected funds, tax withholdings, and non-offsettable obligations) and computes a net settlement vector that reduces the number of transfers relative to the gross baseline. The system forms an atomic settlement group across one or more rails and preserves end-to-end correlation identifiers (e.g., ISO 20022 EndToEndId/UETR equivalents) through execution. The Proof-of-Netting receipt may include the computed netting vector, excluded classes, compression metrics, and references to the rulepack and governance pack used for the cycle.

### 12.5 Example: Intercompany and Household Multilateral Netting (Illustrative)

In embodiments, wrapper selection is performed using an entity template library in which nonprofit, foundation-owned, cooperative, and other governance structures are represented as specialized ownership entities with explicit constraints. The system may assign benefit-sharing parameters that route measured surplus to a designated pool, reserve, or regenerative program, and emits a Proof-of-Benefit receipt that references the originating Proof-of-Netting and settlement identifier. Where distributions are performed, the system can enforce surplus pool correctness by binding downstream distribution receipts to a SurplusReceipt identifier and by applying policy predicates that prevent double-counting or misrouting.

In one example, a household participates in multiple employer and provider relationships in a single period. The system aggregates obligations (wages, deductions, premiums, advances, reimbursements) into an ObligationLedger, computes netting via a network-flow solver, and executes a reduced set of net transfers. The system emits a PoN receipt binding gross and net vectors and correlation identifiers used across rails.

### 12.6 Example: Nonprofit Wrapper Selection and Benefit-Sharing Parameter (Illustrative)

In one example, an asset (e.g., operating business cash flows or a portfolio asset) is evaluated under the kernel and the system selects, from a ranked list of candidates, a specialized ownership entity that is a nonprofit or philanthropic enterprise wrapper permitted under applicable law. The system encodes a conveyance record transferring legal title or beneficial interest to the selected entity while preserving user usage rights through a usage-rights instrument. The system computes a benefit-sharing parameter that routes a portion of measured surplus to defined stakeholders (e.g., employees, users, a cooperative pool, or a charitable reserve) and issues receipts binding the wrapper selection, distributions, and governance constraints to the originating settlement cycle.

12.7 Example: Sale-Leaseback Lifecycle Retitling with Continuous Usage (Illustrative)

In one example, a user relies on a vehicle as a productive asset. The system predicts that ownership by a specialized entity (e.g., a fleet entity, cooperative, or financing wrapper) with a usage-rights instrument (e.g., a lease) yields higher collective benefit by lowering financing cost, improving insurance terms, and reducing intermediary fees. The system executes a conveyance transferring title to the selected entity and grants the user continuous usage rights. Over time, as risk signals, usage patterns, and market conditions change, the system repeats the evaluate-and-optimize loop and may re-title the asset among different specialized entities without interrupting user access, issuing updated receipts and netting related obligations (lease payments, insurance premiums, maintenance credits, and taxes) where permitted.

### 12.8 Example: Cross-Rail Atomic Settlement Group Including Token Rails (Illustrative)

In one example, a clearing group has obligations that span traditional banking rails and a programmable token rail. The system computes a net settlement vector and forms an atomic settlement group with legs on each rail. The system issues prepare or reserve operations where supported, uses idempotency keys, and commits settlement legs in a coordinated sequence. Receipts bind rail transaction identifiers, token transaction hashes, and correlation identifiers (e.g., EndToEndId or UETR equivalents) to the Proof-of-Netting receipt, enabling deterministic replay and cross-rail reconciliation.

### 12.9 Example: Mortgage Refinance Timing and Escrow Netting (Illustrative)

In one example, a user holds a mortgage with escrowed property tax and insurance. The system forecasts rate movements and evaluates refinancing options across a set of specialized entities and financing configurations. The system selects an ownership and financing structure that reduces total cost while preserving usage of the home through a usage-rights instrument. The system records escrow contributions, tax deposits, premium payments, refunds, and rebates as obligations, and nets permissible offsets within settlement cycles while enforcing escrow segregation constraints. Receipts bind the refinancing selection, executed settlement legs, and compliance checks (e.g., escrow rules, servicing rules) to the applicable rulepacks.

### 13. Additional Implementation Considerations

### 13.1 Interoperability and Integration

In embodiments, the system integrates with external systems (e.g., payroll, HRIS, benefits administrators, brokers, insurers, lenders, custodians, marketplaces, and accounting systems) via APIs, event streams, file interfaces, or standardized messages. The system can generate actuation messages and confirm results through receipt ingestion.

### 13.2 Data Residency and Locality Constraints

In embodiments, the policy lattice can include data residency constraints that require certain categories of data to remain within specified geographic regions. Shard migration and caching heuristics can incorporate these constraints, ensuring that datasets are migrated only to permitted regions and that inference and receipt generation execute in compliant environments.

### 13.3 Fault Tolerance, Retries, and Idempotency

In embodiments, transaction execution and receipt issuance are implemented as idempotent operations. Each actuation message can include an idempotency key derived from receipt identifiers. The system can detect duplicate executions and can prevent double transfers. Retry logic can be coupled with deterministic replay to reconstruct incomplete cycles.

### 13.4 Performance and Scaling

In embodiments, the combination of int8 quantization, ASIC inference acceleration, shard caching/prefetching, and targeted recomputation reduces compute and latency overhead. Multilateral netting reduces payment message count. Receipt checkpointing reduces audit overhead by enabling selective verification.

### 13.5 Non-Limiting Nature of Embodiments

The embodiments described herein are not intended to be exhaustive. Any features described as optional may be omitted, and features described in separate embodiments may be combined. The scope of the invention is defined by the claims.

### 13.6 Privacy Engineering, Minimization, and Selective Disclosure

In embodiments, the system implements privacy-by-design. For example, receipts can store commitments to sensitive values rather than raw values; credential proofs can demonstrate predicate satisfaction without disclosing underlying attributes; and disclosure budgets can enforce reveal-after-commit policies. Where data must be shared across parties, the system may use tokenization, pseudonymous identifiers (e.g., DIDs), and partitioned receipt views so that each party receives only the minimum necessary information.

### 13.7 Federated Learning and On-Device Inference Alternatives

In embodiments, the categorization engine is trained or updated using federated or distributed learning, where model updates are computed on local nodes and aggregated centrally, reducing movement of raw sensitive data. In some embodiments, inference occurs on edge nodes (e.g., employer nodes or personal devices) and only receipt outputs and commitments are transmitted. These alternatives can further reduce intermediary access to sensitive data and can reduce network bandwidth while maintaining auditability.

### 13.8 Evidence Bundles and External Verification Hand-Offs

In embodiments, the system packages selected receipts and supporting proofs into an evidence bundle suitable for downstream verification by an external authority (e.g., auditor, regulator, plan administrator, or counterparty). Evidence bundles may include receipt chains, Merkle proofs, timestamp tokens, and credential verification proofs. The bundle can be verified independently to confirm that actions were executed under specific rulepacks and governance packs without requiring access to internal source systems.

### 13.9 Physical Embodiments, Edge Enforcement, and Secure Modules

In embodiments, portions of the kernel execute on dedicated hardware and/or edge devices to enforce usage rights, reduce latency, and improve security. For example, a vehicle or facility may include an on-device secure element, TPM, or HSM that verifies UsageContinuityReceipts and selectively enables access (e.g., ignition enablement, door unlock, compute allocation, or device activation) based on cryptographic verification and policy predicates. In another example, an employer, plan administrator, or enterprise participant deploys an on-premises appliance that performs rulepack evaluation, receipt signing, and netting computations within a trusted execution environment (TEE), and synchronizes only receipt digests and permissible aggregates to a central service.

In embodiments, sensors and telemetry sources (e.g., IoT sensors, location beacons, device logs, and time sources) provide observed-usage evidence that is canonicalized and bound into receipts. Location and time constraints may be enforced using geofencing predicates (e.g., GPS/BLE/NFC-derived zones) and cryptographic timestamp tokens, enabling the policy lattice to express temporal and locality constraints without requiring continuous disclosure of raw location data. These physical embodiments support claim amendments directed to technical improvements in security, reduced fraud, reduced attack surface, and verifiable enforcement of usage rights.

In some embodiments, verification is performed by a dedicated auditor appliance (e.g., a portable verification device) configured with public keys and expected receipt schemas and coupled to a read-only feed of receipt headers and witness bundles. The appliance verifies digital signatures and inclusion proofs against a known checkpoint root, performs deterministic replay of selected receipts by recomputing pre-state and post-state hashes, and emits VerificationReceipts identifying discrepancies and aggregate statistics. These hardware embodiments tie verification to particular machines and reduce reliance on trusted third parties for audit.

In some embodiments, participants use a secure commit-controller device (e.g., a fob or mobile secure element) to generate signatures, store private keys, and present consent or authorization artifacts under controlled disclosure. For example, a commit-controller may sign a usage-rights grant, a wrapper-binding authorization, or a high-risk settlement approval, and the resulting signature is bound into the corresponding receipt.

### 14. Additional Amendment Support and Claim Variations

The disclosure above is structured to support an allowance-first claim track while also providing written-description support for amendments and continuation practice. The following non-limiting claim variations are supported as embodiments of the same kernel and may be used, for example, to respond to prior art, to address eligibility concerns, or to pursue additional coverage in continuations.

14.1 Receipt-native transaction compression as a claim focus: In embodiments, the kernel includes generating typed receipts that bind gross obligations, offsets applied, exclusions, and a net settlement vector, and executing an atomic settlement group across heterogeneous rails while preserving end-to-end identifiers. This embodiment supports claim amendments emphasizing reduced message count, reduced intermediary hops, and cryptographically verifiable auditability.

14.2 Policy-lattice change adaptation as a claim focus: In embodiments, the kernel includes compiling rulepacks from jurisdictional deltas, invalidating dependent cached decisions, and triggering targeted recomputation, with LawDeltaReceipts and RecomputeReceipts binding effective dates, affected nodes, and resulting decisions. This embodiment supports claim amendments emphasizing technical management of policy versioning and replayable compliance.

14.3 Secure enclave attestation as a claim focus: In embodiments, the kernel includes executing inference and receipt generation in a trusted execution environment and binding remote attestation evidence into receipt bundles, enabling a verifier to confirm execution by an authorized model and code version.

14.4 Opaque-to-transparent matching as a claim focus: In embodiments, the kernel includes matching containerized supply and demand using predicate proofs under disclosure budgets, issuing usage-only tokens, and emitting RevealReceipts and completion evidence to update trust coefficients.

14.5 Surplus measurement and regenerative routing as a claim focus: In embodiments, the kernel includes computing surplus attributable to compression, optimization, and automation, and routing that surplus per benefit-sharing parameters while issuing SurplusReceipts and downstream distribution receipts bound to a settlement cycle.

14.6 Version binding and deterministic replay as a claim focus: In embodiments, receipts and evidence bundles bind explicit version identifiers (e.g., model_hash, rulepack_hash, governance_pack_hash, and code/attestation measurements) such that later replay and verification can be performed against the same versions. This posture supports amendments focused on technical auditability, reproducibility, and secure execution as practical applications of AI and policy evaluation.

14.7 Intermediary internalization control as a claim focus: In embodiments, claims may recite computing an interdependence index, maintaining a state machine for an intermediary function, and emitting TransitionReceipts that bind metric snapshots and routing/settlement changes. This provides a technical framing for disintermediation and phased removal of external dependencies.

14.8 Asset wrapper engine and parcelization as a claim focus: In embodiments, claims may recite generating AssetParcels, evaluating wrapper templates under a policy lattice, emitting WrapperEvaluationReceipts and WrapperBindingReceipts, and rebinding wrappers over time while preserving usage continuity. This supports claiming hybrid asset classes and ownership-from-usage detachment with machine-checkable wrapper constraints.

14.9 Receipt-spine compression as a claim focus: In embodiments, claims may recite storing witness objects in a content-addressed store, embedding witnessRefs hashes in receipts, constructing a Merkle-DAG of receipt headers and witness objects, and generating checkpoint roots for stateless verification. This provides additional technical claim hooks related to storage reduction, audit distribution, and integrity verification.

What is claimed is:

1. A system for allocating asset ownership for maximized collective economic benefit, the system comprising:
a) at least one computer system comprising a processor and a memory storing executable instructions, wherein the processor executes the instructions to:
i) receive information about a user and an asset used or to be used by the user;
ii) store neural-network weights as a 32-bit floating-point variable;
iii) store neural-network activations as a 32-bit floating-point variable;
iv) statically quantize neural-network weights and neural-network activations as 8-bit integers, wherein the neural-network weights are quantized to reduce storage footprint;
v) ingest asset-utilization transaction data containing historical sale, lease, usage and user-profile records for the user-asset pair; and
vi) retrieve supplemental historical datasets of economic outcomes and user demographics;
vii) utilize an application-specific integrated circuit (ASIC) for an artificial neural network connected to the memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and circuitry operable to execute a functionally invariant path (FIP) algorithm that updates network weights along differential-geometry paths so as to preserve learned behavior while increasing sparsity wherein the array is configured to analyze said business sale transaction information, asset usage, ownership structures, and economic outcomes, trained on historical datasets including a parameter for each of business sale transaction information, asset usage, ownership structures, and economic outcomes, wherein the AI/ML categorization engine makes a prediction regarding the most efficient use(s) of an asset;
viii) wherein during the training process the ASIC uses supervised learning, where labeled datasets containing known inputs and desired outputs are fed into the network; the neural network adjusts its internal weights using a backpropagation algorithm, which minimizes the difference between the network's predictions and the actual outcomes as measured by a mean squared error loss function and the ASIC iteratively refines its predictions until the error rate falls below a predefined threshold, ensuring that the network can make accurate predictions on new, unseen data;
ix) wherein the ASIC is further configured to:
x) execute a artificial intelligence machine learning categorization engine on the asset-utilization transaction data and output a predicted most-efficient-use vector for the asset;
xi) compare the ASIC output to the user's declared or observed usage pattern and flag in the data structure a projected differential meeting or exceeding a predefined threshold ownership inefficiency;
xii) issue a query to an ownership-entity database and return a ranked candidate list of specialized entities;
xiii) compute the maximum function output value of expected collective economic benefit across the candidate list and select the top-ranked entity;
xiv) encode a parameter for a transaction execution that transfers legal title to the selected entity while preserving usage rights for the user, wherein encoding the transfer and preservation of usage rights comprises: generating, in memory, a conveyance record designating the selected ownership entity as owner of the asset and a usage-agreement record granting the user possession or access under a lease, rental, or long-term usage agreement; executing the conveyance and usage agreement; storing the executed records in a database of assets, ownership entities, and users; and calculating and storing a benefit-sharing parameter to be redistributed to the user; and
xv) wherein the memory further stores instructions that cause the system to:
xvi) migrate dataset shards between distributed memory devices in different geospatial data centers whenever a latency-or-cost heuristic is met to sustain parallel low-latency access, wherein migrating dataset shards between geospatial data centers comprises caching frequently accessed data and prefetching anticipated data to reduce access latency;
xvii) repeat, using the ASIC, an evaluate and optimize process to detect that re-titling of an asset would deliver an improvement above a set threshold and invoke another title-transfer routine that assigns the asset to a newly selected entity without interrupting user access;
xviii) apply the FIP algorithm to newly accumulated asset-utilization transaction data so as to refine prediction accuracy while preserving prior knowledge; and
xix) dispatch an electronic alert to the user confirming continuity of usage following an ownership reassignment.

2. The system of claim 1, wherein the processor further executes instructions to generate, for each title-transfer routine, a cryptographically verifiable receipt bundle comprising: (i) a model identifier of a model version used to generate the predicted most-efficient-use vector; (ii) the predicted most-efficient-use vector; (iii) an identifier of the selected ownership entity; (iv) a hash of executed records that include a conveyance record and a usage-agreement record associated with the transaction execution; (v) a rulepack identifier and rulepack hash identifying constraints evaluated for the title-transfer routine; and (vi) a timestamp token; and to store the receipt bundle in an append-only event ledger that is hash-linked to prior receipt bundles and is configured for deterministic replay.

3. The system of claim 2, wherein the receipt bundle comprises a Proof-of-Netting (PoN) receipt that binds, for a settlement cycle, (i) a gross obligation vector, (ii) an offset vector, (iii) an exclusion mask identifying obligations that are not eligible for setoff, and (iv) a settlement identifier that links payment legs and receipts; and wherein the processor further executes instructions to compute a multilateral netting across a clearing group based on the gross obligation vector and the exclusion mask to generate a net settlement vector, and to output payment instructions according to the net settlement vector while preserving the settlement identifier through downstream payment processing.

4. The system of claim 3, wherein computing the multilateral netting comprises solving a network-flow optimization that minimizes gross settlement volume subject to (i) conservation-of-value constraints per clearing-group participant and (ii) setoff-right constraints stored in a setoff policy matrix, and wherein the PoN receipt includes, for each excluded obligation, a reason code identifying a policy node of the setoff policy matrix that caused exclusion and an instruction to settle the excluded obligation as a linked gross settlement leg that references the reason code.

5. The system of claim 3, wherein the asset comprises at least one of (i) an employee stock purchase plan (ESPP) entitlement, (ii) a retirement-plan matching entitlement, or (iii) a benefits-eligibility right; and wherein the processor further executes instructions to: (a) issue an internalized advance to fund a payroll-aligned deduction for plan participation; (b) configure one or more brokerage, plan-administration, or trustee settlement legs associated with the plan participation; (c) encode a repayment of the internalized advance that is automatically netted from a subsequent settlement cycle; and (d) generate a Proof-of-Benefit (PoB) receipt that is linked, by the settlement identifier, to the PoN receipt that reflects the netted repayment.

6. The system of claim 3, wherein the asset comprises a unit of work performed by the user, and wherein the processor further executes instructions to: (a) apply a jurisdiction-specific, versioned rulepack to classify the unit of work as an employee classification or an independent-contractor classification; (b) generate a Proof-of-Classification (PoC) receipt that binds (i) a work identifier, (ii) a jurisdiction identifier, and (iii) a rulepack identifier and rulepack hash used for classification; and (c) actuate payroll, withholding, and benefits settings according to the classification and include at least one resulting obligation in the gross obligation vector used to compute the multilateral netting for the settlement cycle, wherein the actuation is recorded in the append-only event ledger as a typed receipt linked to the PoC receipt and to the settlement identifier.

7. The system of claim 6, wherein applying the rulepack comprises evaluating Affordable Care Act (ACA) affordability using at least one safe-harbor test, selecting among a W-2 safe harbor, a rate-of-pay safe harbor, and a federal poverty line safe harbor, and generating a compliance receipt that identifies (i) a selected safe-harbor method and (ii) a set of inputs used to determine affordability; and wherein the actuation includes updating a benefits enrollment or premium contribution amount based on the selected safe-harbor method.

8. The system of claim 3, wherein the clearing group comprises (i) a household participant and (ii) an intercompany participant, and wherein computing the multilateral netting produces, for each clearing-group participant, a single net payable or net receivable for the settlement cycle while preserving the settlement identifier unchanged through downstream processing and while emitting, in the PoN receipt, a mapping from gross obligations to the single net payable or net receivable.

9. The system of claim 2, wherein the ranked candidate list of specialized entities comprises at least one nonprofit entity, foundation, cooperative, donor-advised fund, or purpose trust, and wherein the benefit-sharing parameter routes a measured surplus value attributable to the ownership reassignment to at least one of a user pool, a community pool, or a philanthropic pool according to a distribution ruleset identifier, and wherein the receipt bundle further comprises a surplus receipt that binds the measured surplus value to the title-transfer routine.

10. The system of claim 3, wherein outputting the payment instructions comprises executing an atomic settlement group across heterogeneous payment rails including a bank payment rail and a programmable token rail, and wherein executing the atomic settlement group comprises performing a two-phase commit such that all settlement legs succeed or else all settlement legs are rolled back, and storing, in the append-only event ledger, a settlement manifest that references rail-specific transaction identifiers for each settlement leg and that is linked to the PoN receipt.

11. A computer-implemented method for allocating asset ownership for maximized collective economic benefit, the method comprising:
receiving, by at least one processor, information about a user and an asset used or to be used by the user;
storing neural-network weights as a 32-bit floating-point variable;
storing neural-network activations as a 32-bit floating-point variable;
statically quantizing neural-network weights and neural-network activations as 8-bit integers, wherein the neural-network weights are quantized to reduce storage footprint;
ingesting asset-utilization transaction data containing historical sale, lease, usage and user-profile records for the user-asset pair; and retrieving supplemental historical datasets of economic outcomes and user demographics;
utilizing an application-specific integrated circuit (ASIC) for an artificial neural network connected to the memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and circuitry operable to execute a functionally invariant path (FIP) algorithm that updates network weights along differential-geometry paths so as to preserve learned behavior while increasing sparsity wherein the array is configured to analyze said business sale transaction information, asset usage, ownership structures, and economic outcomes, trained on historical datasets including a parameter for each of business sale transaction information, asset usage, ownership structures, and economic outcomes, wherein the AI/ML categorization engine makes a prediction regarding the most efficient use(s) of an asset;
wherein during the training process the ASIC uses supervised learning, where labeled datasets containing known inputs and desired outputs are fed into the network; the neural network adjusts its internal weights using a backpropagation algorithm, which minimizes the difference between the network's predictions and the actual outcomes as measured by a mean squared error loss function and the ASIC iteratively refines its predictions until the error rate falls below a predefined threshold, ensuring that the network can make accurate predictions on new, unseen data;
executing, by the ASIC, a artificial intelligence machine learning categorization engine on the asset-utilization transaction data and outputting a predicted most-efficient-use vector for the asset;
comparing the ASIC output to the user's declared or observed usage pattern and flagging a projected differential meeting or exceeding a predefined threshold ownership inefficiency; issuing a query to an ownership-entity database and returning a ranked candidate list of specialized entities; computing the maximum function output value of expected collective economic benefit across the candidate list and selecting the top-ranked entity; encoding a parameter for a transaction execution that transfers legal title to the selected entity while preserving usage rights for the user, wherein encoding the transfer and preservation of usage rights comprises: generating, in memory, a conveyance record designating the selected ownership entity as owner of the asset and a usage-agreement record granting the user possession or access under a lease, rental, or long-term usage agreement; executing the conveyance and usage agreement; storing the executed records in a database of assets, ownership entities, and users; and calculating and storing a benefit-sharing parameter to be redistributed to the user; and migrating dataset shards between distributed memory devices in different geospatial data centers whenever a latency-or-cost heuristic is met to sustain parallel low-latency access, wherein migrating dataset shards between geospatial data centers comprises caching frequently accessed data and prefetching anticipated data to reduce access latency; repeating, using the ASIC, an evaluate and optimize process to detect that re-titling of an asset would deliver an improvement above a set threshold and invoking another title-transfer routine that assigns the asset to a newly selected entity without interrupting user access; applying the FIP algorithm to newly accumulated asset-utilization transaction data so as to refine prediction accuracy while preserving prior knowledge; and dispatching an electronic alert to the user confirming continuity of usage following an ownership reassignment.

12. The method of claim 11, further comprising generating, for each title-transfer routine, a cryptographically verifiable receipt bundle comprising at least a model identifier, the predicted most-efficient-use vector, an identifier of the selected ownership entity, a hash of executed records, a rulepack hash, and a timestamp token, and storing the receipt bundle in an append-only event ledger configured for deterministic replay.

13. The method of claim 12, wherein storing the receipt bundle in the append-only event ledger comprises computing periodic checkpoint digests over receipt bundles using a Merkle-tree construction to enable membership proofs for individual receipt bundles.

14. The method of claim 12, further comprising, for each settlement cycle, computing multilateral netting across a consented clearing group to minimize gross settlement volume subject to setoff constraints and generating a Proof-of-Netting receipt that binds gross obligation vectors, offsets, exclusions, and a settlement identifier linking payment legs to receipt bundles.

15. The method of claim 14, wherein the asset comprises an employee stock purchase plan (ESPP) entitlement or a retirement-plan matching entitlement, and wherein the method further comprises issuing an internalized advance to fund plan participation and netting repayment of the internalized advance from subsequent settlement cycles, and generating a Proof-of-Benefit receipt linked to the Proof-of-Netting receipt.

16. The method of claim 14, wherein the asset comprises a unit of work, and wherein the method further comprises applying a jurisdiction-specific rulepack to classify the unit of work as employee or independent contractor, generating a Proof-of-Classification receipt that binds a rulepack hash and a work identifier, actuating payroll withholding or benefits settings according to the classification, and including at least one resulting obligation in the gross obligation vectors used to compute the multilateral netting.

17. The method of claim 16, further comprising ingesting a change-of-law update, updating a versioned rulepack used for classification, emitting a law-delta receipt, and triggering incremental recomputation of at least one classification or settlement output for an affected cohort without recomputing records for unaffected cohorts.

18. A non-transitory computer-readable medium storing instructions that, when executed by at least one processor, cause a computing system to perform operations comprising:
receiving information about a user and an asset used or to be used by the user;
storing neural-network weights as a 32-bit floating-point variable;
storing neural-network activations as a 32-bit floating-point variable;
statically quantizing neural-network weights and neural-network activations as 8-bit integers, wherein the neural-network weights are quantized to reduce storage footprint;
ingesting asset-utilization transaction data containing historical sale, lease, usage and user-profile records for the user-asset pair; and retrieving supplemental historical datasets of economic outcomes and user demographics;
utilizing an application-specific integrated circuit (ASIC) for an artificial neural network connected to the memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and circuitry operable to execute a functionally invariant path (FIP) algorithm that updates network weights along differential-geometry paths so as to preserve learned behavior while increasing sparsity wherein the array is configured to analyze said business sale transaction information, asset usage, ownership structures, and economic outcomes, trained on historical datasets including a parameter for each of business sale transaction information, asset usage, ownership structures, and economic outcomes, wherein the AI/ML categorization engine makes a prediction regarding the most efficient use(s) of an asset;
wherein during the training process the ASIC uses supervised learning, where labeled datasets containing known inputs and desired outputs are fed into the network; the neural network adjusts its internal weights using a backpropagation algorithm, which minimizes the difference between the network's predictions and the actual outcomes as measured by a mean squared error loss function and the ASIC iteratively refines its predictions until the error rate falls below a predefined threshold, ensuring that the network can make accurate predictions on new, unseen data;
wherein the ASIC is further configured to:
execute a artificial intelligence machine learning categorization engine on the asset-utilization transaction data and output a predicted most-efficient-use vector for the asset;
compare the ASIC output to the user's declared or observed usage pattern and flag in the data structure a projected differential meeting or exceeding a predefined threshold ownership inefficiency; issue a query to an ownership-entity database and return a ranked candidate list of specialized entities; compute the maximum function output value of expected collective economic benefit across the candidate list and select the top-ranked entity; encode a parameter for a transaction execution that transfers legal title to the selected entity while preserving usage rights for the user, wherein encoding the transfer and preservation of usage rights comprises: generating, in memory, a conveyance record designating the selected ownership entity as owner of the asset and a usage-agreement record granting the user possession or access under a lease, rental, or long-term usage agreement; executing the conveyance and usage agreement; storing the executed records in a database of assets, ownership entities, and users; and calculating and storing a benefit-sharing parameter to be redistributed to the user; and wherein the computer-readable medium further stores instructions that cause the computing system to: migrate dataset shards between distributed memory devices in different geospatial data centers whenever a latency-or-cost heuristic is met to sustain parallel low-latency access, wherein migrating dataset shards between geospatial data centers comprises caching frequently accessed data and prefetching anticipated data to reduce access latency; repeat, using the ASIC, an evaluate and optimize process to detect that re-titling of an asset would deliver an improvement above a set threshold and invoke another title-transfer routine that assigns the asset to a newly selected entity without interrupting user access; apply the FIP algorithm to newly accumulated asset-utilization transaction data so as to refine prediction accuracy while preserving prior knowledge; and dispatch an electronic alert to the user confirming continuity of usage following an ownership reassignment; and storing, in an append-only event ledger, cryptographically verifiable receipts associated with at least the transaction execution and the selection.

19. The non-transitory computer-readable medium of claim 18, wherein the instructions further cause the computing system to generate typed receipts comprising at least a Proof-of-Classification receipt, a Proof-of-Netting receipt, and a Proof-of-Benefit receipt, each receipt binding a corresponding rulepack hash or settlement identifier to enable deterministic replay.

20. The non-transitory computer-readable medium of claim 18, wherein the instructions further cause the computing system to compute multilateral netting across a clearing group and to execute an atomic settlement group across heterogeneous payment rails with a two-phase commit protocol, and to store a settlement manifest linking rail transaction identifiers to the Proof-of-Netting receipt.
